(19) United States
(12) Patent Application Publication
(10) Pub. No.: US 2015/0081587 A1
(43) Pub. Date: Mar. 19, 2015

(54) CUSTOMER CONTROLLED MANAGEMENT OF SHIPMENTS

(71) Applicant: United Parcel Service of America, Inc., Atlanta, GA (US)

(72) Inventor: ROBERT J. GILLEN, ALPHARETTA, GA (US)

(73) Assignee: United Parcel Service of America, Inc., Atlanta, GA (US)

(21) Appl. No.: 14/025,893

(22) Filed: Sep. 13, 2013

(51) Int. Cl. G06Q 10/08

(52) U.S. Cl. CPC G06Q 10/08355
USPC 705/338

(57) ABSTRACT

Systems, methods, apparatus, and computer program products are provided for customer controlled management of shipments. For example, in various embodiments, a customer can provide information prior to a first delivery or pickup attempt of an item by a carrier to receive messages regarding shipment of the item and to have the item delivered or picked up in accordance with an automatic service schedule.

### BACKGROUND

Shipping customers are increasing their expectations regarding various delivery services. Thus, new concepts are needed to enhance customer experience and loyalty by improving the delivery experience.

### BRIEF SUMMARY

In general, embodiments of the present invention provide systems, methods, apparatus, and computer program products for customer controlled management of shipments.

In accordance with one aspect, a method for an automatic delivery schedule is provided. In one embodiment, the method comprises (1) storing shipping data corresponding to an item to be delivered to a first delivery point by a carrier for a customer; (2) identifying a customer-defined delivery schedule that identifies customer preferences for delivering items for the customer; and (3) after identifying the customer-defined delivery schedule, automatically updating the shipping data corresponding to the item to reflect that the item should be re-routed for delivery to a second delivery point based on the customer-defined delivery schedule, wherein the item is subsequently delivered to the second delivery point.

In accordance with another aspect, a computer program product for an automatic delivery schedule is provided. The computer program product may comprise at least one computer-readable storage medium having computer-readable program code portions stored therein, the computer-readable program code portions comprising executable portions configured to (1) store shipping data corresponding to an item to be delivered to a first delivery point by a carrier for a customer; (2) identify a customer-defined delivery schedule that identifies customer preferences for delivering items for the customer; and (3) after identifying the customer-defined delivery schedule, automatically update the shipping data corresponding to the item to reflect that the item should be re-routed for delivery to a second delivery point based on the customer-defined delivery schedule, wherein the item is subsequently delivered to the second delivery point.

In accordance with yet another aspect, an apparatus comprising at least one processor and at least one memory including computer program code is provided. In one embodiment, the at least one memory and the computer program code may be configured to, with the processor, cause the apparatus to at least (1) store shipping data corresponding to an item to be delivered to a first delivery point by a carrier for a customer; (2) identify a customer-defined delivery schedule that identifies customer preferences for delivering items for the customer; and (3) after identifying the customer-defined delivery schedule, automatically update the shipping data corresponding to the item to reflect that the item should be re-routed for delivery to a second delivery point based on the customer-defined delivery schedule, wherein the item is subsequently delivered to the second delivery point.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a carrier system according to one embodiment of the present invention.

FIG. 3 is an exemplary schematic diagram of a mobile station according to one embodiment of the present invention.

FIG. 4 is a flowchart illustrating operations and processes that can be used in accordance with various embodiments of the present invention.

FIGS. 5-14, 15A, 15B, 16-18, 19A, 19B, 20-25, 26A, 26B, 27, and 28 show exemplary input and output of various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Methods, Apparatus, Systems, and Computer Program Products

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. Exemplary System Architecture

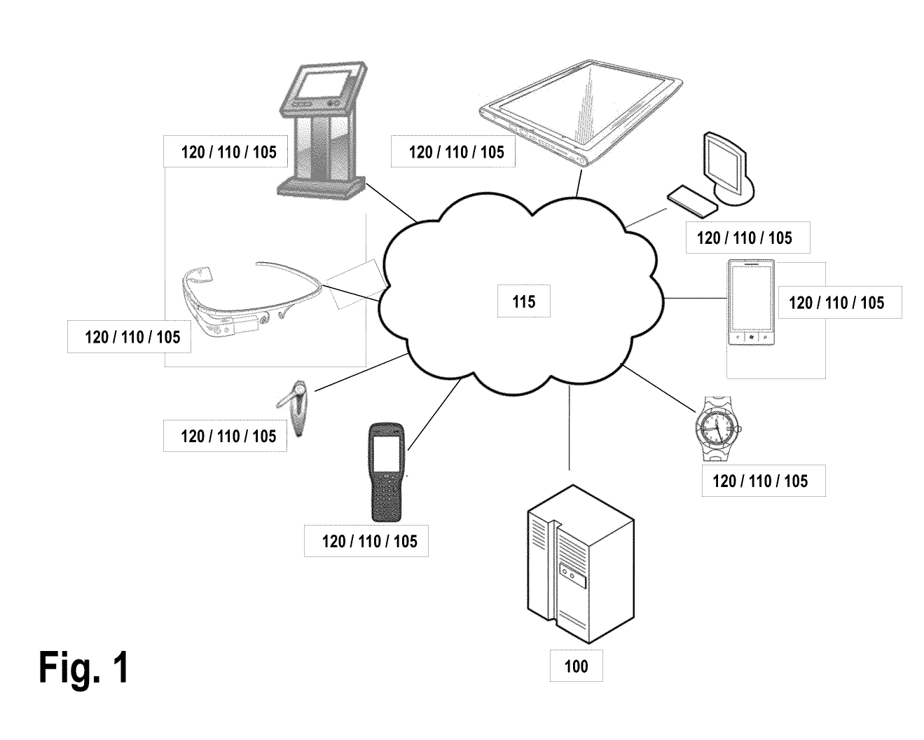

FIG. 1 provides an illustration of a system that can be used in conjunction with various embodiments of the present invention. As shown in FIG. 1, the system may include one or more carrier systems 100, one or more mobile stations 105, one or more consignee computing devices 110, and one or more networks 115, and one or more consignor computing devices 120. Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), or the like. Additionally, while FIG. 1 illustrates certain communication system entities as separate, standalone entities, the various embodiments are not limited to this particular architecture.

### 1. Exemplary Carrier System

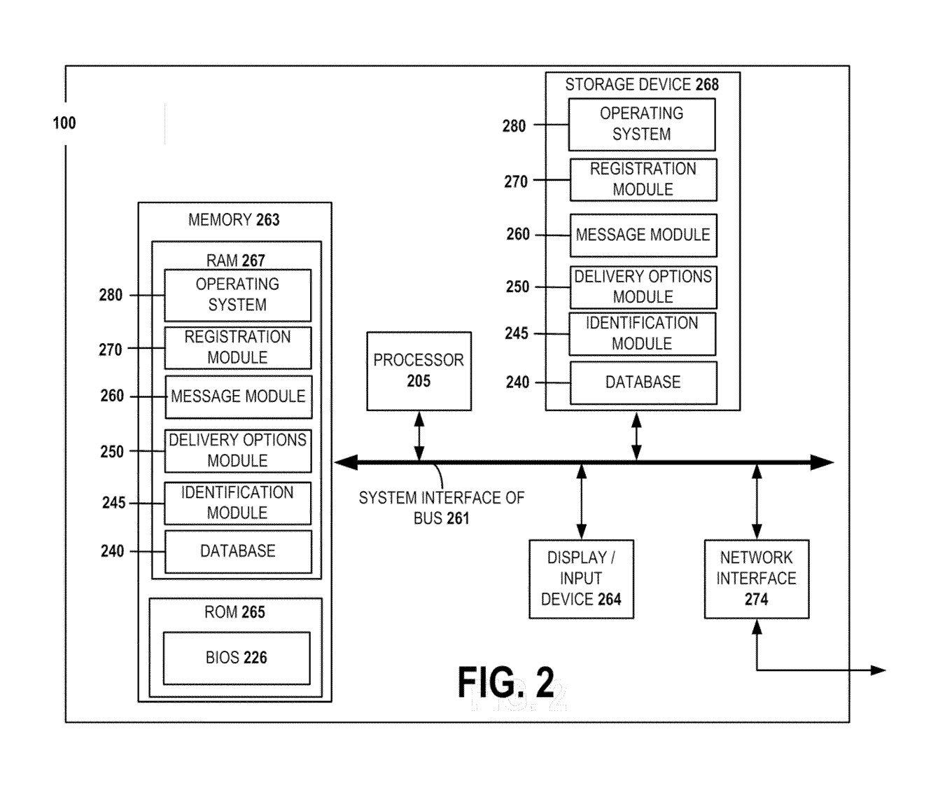

FIG. 2 provides an exemplary schematic of a carrier system 100 according to one embodiment of the present invention. In general, the term “system” may refer to, for example, one or more computers, computing entities, computing devices, mobile phones, gaming consoles (e.g., Xbox, Play Station, Wii), desktops, tablets, notebooks, laptops, distributed systems, servers or server networks, blades, gateways, switches, processing devices, processing entities, set-top boxes, relays, routers, network access points, base stations, the like, and/or any combination of devices or entities adapted to perform the functions, operations, and/or processes described herein. However, the carrier system 100 may also comprise various other systems, such as an Address Matching System (AMS), an Internet Membership System (IMS), a Customer Profile System (CPS), a Package Center Information System (PCIS), a Customized Pickup and Delivery System (CPAD), a Web Content Management System (WCMS), a Notification Email System (NES), a Fraud Prevention System (FPS), and a variety of other systems and their corresponding components. The carrier system 100 may also be in communication with various payment networks/systems for carrying out or facilitating the payment of fees. As will be recognized, the payment of such fees may be in a variety of forms, such as via debit cards, credit cards, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like.

As will be understood from FIG. 1, in one embodiment, the carrier system 100 includes one or more processors 205 that communicate with other elements within the carrier system 100 via a system interface or bus 261. The processor 205 may be embodied in a number of different ways. For example, the processor 205 may be embodied as a processing element, processing circuitry, a coprocessor, a controller or various other processing devices including integrated circuits such as, for example, an application specific integrated circuit (ASIC), a field programmable gate array (FPGA), a hardware accelerator, or the like.

In an exemplary embodiment, the processor 205 may be configured to execute instructions stored in memory or otherwise accessible to the processor 205. As such, whether configured by hardware or software methods, or by a combination thereof, the processor 205 may represent an entity capable of performing operations according to embodiments of the present invention when configured accordingly. A display device/input device 264 for receiving and displaying data may also be included in the carrier system 100. This display device/input device 264 may be, for example, a keyboard or pointing device that is used in combination with a monitor. The carrier system 100 may further include transitory and non-transitory memory 263, which may include both random access memory (RAM) 267 and read only memory (ROM) 265. The carrier system's ROM 265 may be used to store a basic input/output system (BIOS) 226 containing the basic routines that help to transfer information to the different elements within the carrier system 100.

In addition, in one embodiment, the carrier system 100 may include at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EEPROM), flash memory, hard disk, or the like. Additionally, each of these storage devices 268 may be connected to the system bus 261 by an appropriate interface.

Furthermore, a number of executable instructions, applications, program modules, and/or the like may be stored by the various storage devices 268 and/or within RAM 267. Such executable instructions, applications, program modules, and/or the like may include an operating system 280, a registration module 270, an alert module 260, a delivery options module 250, an identification module 245, a service schedule module, and/or the like. As discussed in more detail below, these executable instructions, applications, program modules, and/or the like may control certain aspects of the operation of the carrier system 100 with the assistance of the processor 205 and operating system 280—although their functionality need not be modularized. In addition to the program modules, the carrier system 100 may store or be in communication with one or more databases, such as database 240.

Also located within the carrier system 100, in one embodiment, is a network interface 274 for interfacing with various computing entities (e.g., with one or more mobile stations 105). For example, the carrier system 100 may be able to receive data and/or messages from and transmit data and/or messages to the mobile station 105, consignee computing devices 110, and consignor computing devices 120. This communication may be via the same or different wired or wireless networks (or a combination of wired and wireless networks). For instance, the communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the carrier system 100 may be configured to communicate via wireless external communication networks using any of a variety of protocols, such as 802.11, general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth™ protocols, near field communication (NFC) protocols, wireless universal serial bus (USB) protocols, and/or any other wireless protocol.

It will be appreciated that one or more of the carrier system's 100 components may be located remotely from other carrier system 100 components. Furthermore, one or more of the components may be combined and additional components performing functions described herein may be included in the carrier system 100.

### 2. Exemplary Mobile Station

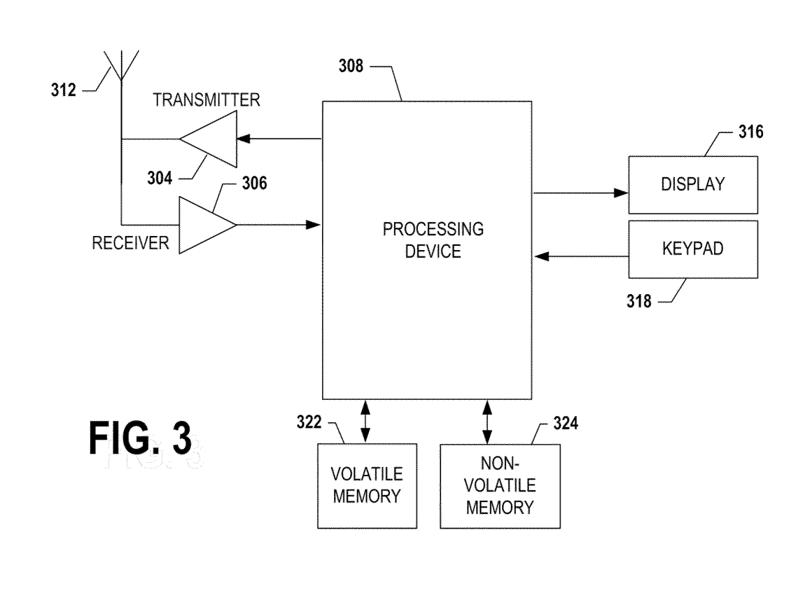

FIG. 3 provides an illustrative schematic representative of a mobile station 105 that can be used in conjunction with the embodiments of the present invention. Mobile stations 105 can be operated by various parties, including carrier personnel (e.g., delivery drivers, sorters, and/or the like). As shown in FIG. 3, the mobile station 105 can include an antenna 312, a transmitter 304 (e.g., radio), a receiver 306 (e.g., radio), and a processing device 308 (e.g., a processor, controller, and/or the like) that provides signals to and receives signals from the transmitter 304 and receiver 306, respectively.

The signals provided to and received from the transmitter 304 and the receiver 306, respectively, may include signaling information in accordance with an air interface standard of applicable wireless systems. In this regard, the mobile station 105 may be capable of operating with one or more air interface standards, communication protocols, modulation types, and access types. More particularly, the mobile station 105 may operate in accordance with any of a number of wireless communication standards and protocols, such as those described above with regard to the carrier system 100. In a particular embodiment, the mobile station 105 may operate in accordance with multiple wireless communication standards and protocols (e.g., using a Gobi radio), such as such as 802.11, GPRS, UMTS, CDMA2000, 1xRTT, WCDMA, TD-SCDMA, LTE, E-UTRAN, EVDO, HSPA, HSDPA, Wi-Fi, WiMAX, UWB, IR, Bluetooth™, NFC, wireless USB protocols, and/or any other wireless protocol and/or multiple wireless carriers. To do so, the mobile station 105 may include integrated mobile reception diversity and integrated power management. Such a configuration can provide for global connectivity to the user.

Via these communication standards and protocols, the mobile station 105 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The mobile station 105 can also download changes, add-ons, and updates, for instance, to its firmware, software (e.g., including executable instructions, applications, program modules), and operating system.

According to one embodiment, the mobile station 105 may include a location determining device and/or functionality. For example, the mobile station 105 may include a Global Positioning System (GPS) module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile station 105 may also comprise a user interface (that can include a display 316 coupled to a processing device 308) and/or a user input interface (coupled to the processing device 308). The user input interface can comprise any of a number of devices allowing the mobile station 105 to receive data, such as a keypad 318, a touch display, voice or motion interfaces, or other input device. In embodiments including a keypad 318, the keypad 318 can include the conventional numeric (0-9) and related keys (#, *), and other keys used for operating the mobile station 105 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile station 105 can also include volatile memory 322 and/or non-volatile memory 324, which can be embedded and/or may be removable. For example, the non-volatile memory may be embedded or removable MMCs, secure digital SD memory cards, Memory Sticks, EEPROM, flash memory, hard disk, or the like. The memory can store any of a number of pieces or amount of information and data used by the mobile station 105 to implement the functions of the mobile station 105. The memory can also store content, such as computer program code for an application and/or other computer programs.

### 3. Exemplary Consignee Computing Device

The consignee computing devices 110 may each include one or more components that are functionally similar to those of the carrier system 100 and/or mobile station 105. For example, in one embodiment, each of the consignee computing devices may include: (1) a processor that communicates with other elements via a system interface or bus; (2) a user interface; (3) transitory and non-transitory memory; and (4) a communications interface. As noted, the consignee computing device 110 may comprise a user interface (that can include a display device/input device coupled to a processing element 308) and/or a user input interface (coupled to a processing element 308). For example, the user interface may be a carrier application, browser, user interface, dashboard, webpage, and/or similar words used herein interchangeably executing on and/or accessible via the consignee computing device 110 to interact with and/or cause display of information from the carrier system 100, as described herein. These architectures are provided for exemplary purposes only and are not limiting to the various embodiments. In general, the terms device, system, computing entity, entity, and/or similar words used herein interchangeably may refer to, for example, one or more computers, computing entities, mobile phones, desktops, tablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. A customer may refer to either a consignor (e.g., a party shipping an item via carrier) or a consignee (e.g., a party receiving an item from a carrier). In the returns context, a consignee who received an item can become a consignor when returning an item.

### 4. Exemplary Consignor Computing Device

The consignor computing devices 120 may each include one or more components that are functionally similar to those of the carrier system 100, mobile station 105, and/or consignee computing device 110. For example, in one embodiment, each of the consignor computing devices may include: (1) a processor that communicates with other elements via a system interface or bus; (2) a user interface; (3) transitory and non-transitory memory; and (4) a communications interface. As noted, the consignor computing device 120 may comprise a user interface (that can include a display device/input device coupled to a processing element 308) and/or a user input interface (coupled to a processing element 308). For example, the user interface may be a carrier application, browser, user interface, dashboard, webpage, and/or similar words used herein interchangeably executing on and/or accessible via the consignor computing device 120 to interact with and/or cause display of information from the carrier system 100, as described herein. These architectures are provided for exemplary purposes only and are not limiting to the various embodiments. A customer may refer to a consignor (e.g., a party shipping an item via carrier), a consignee (e.g., a party receiving an item from a carrier) a third party, and/or the like. In the returns context, a consignor who shipped an item can become a consignee when an item is being returned.

### III. Exemplary System Operation

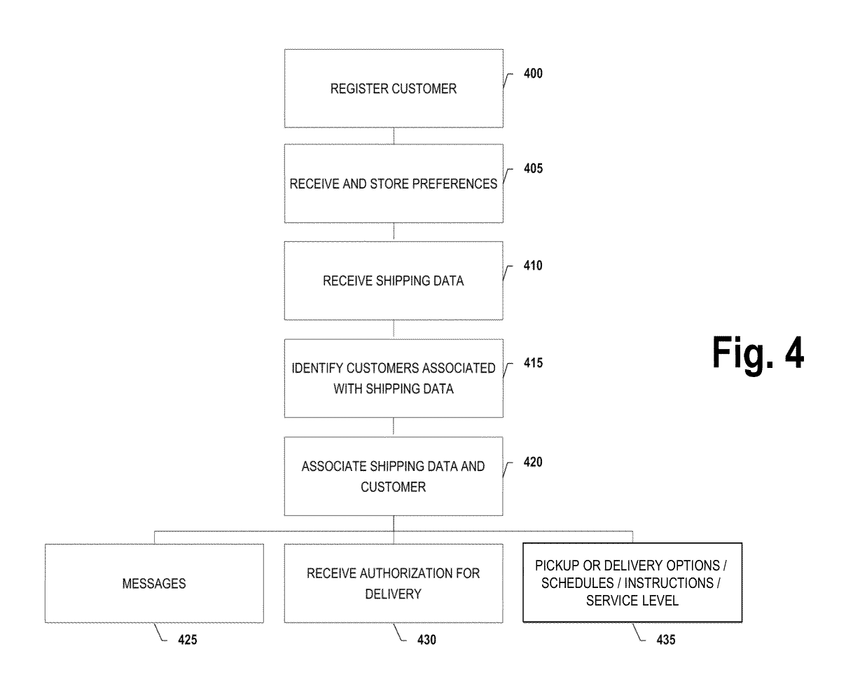

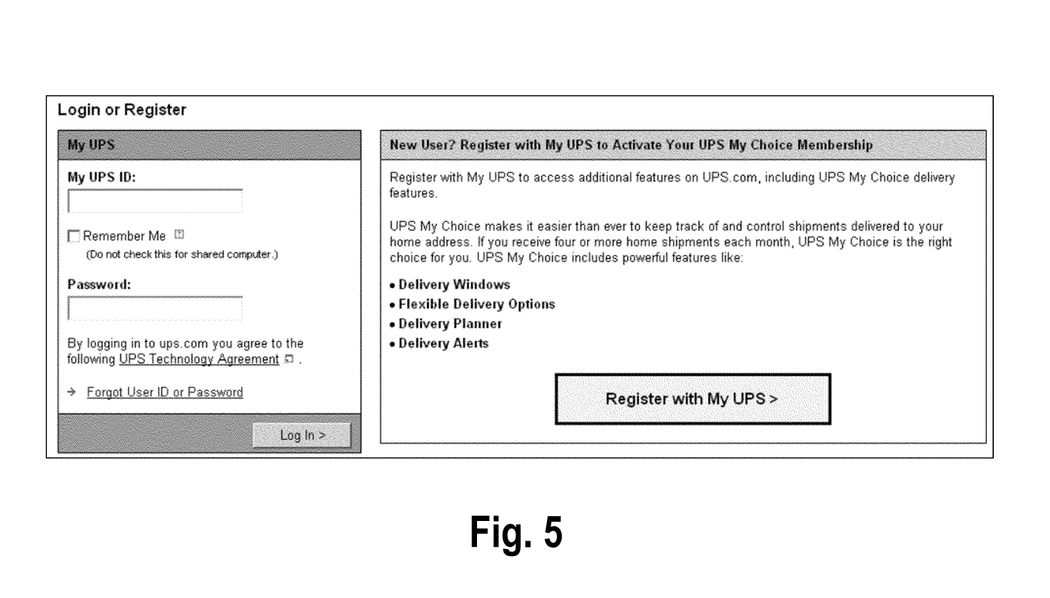

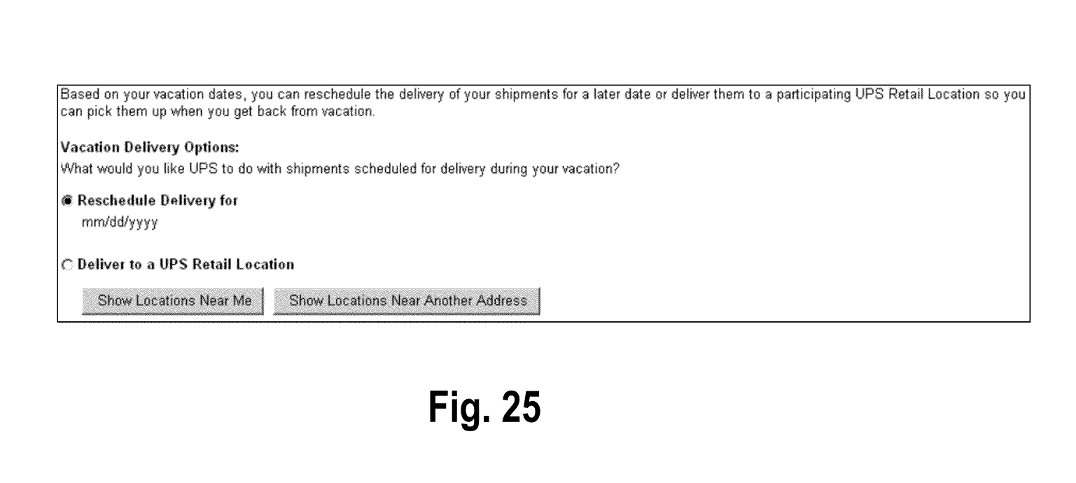

Reference will now be made to FIGS. 4-14, 15A, 15B, 16-18, 19A, 19B, 20-25, 26A, 26B, 27, and 28. FIG. 4 is a flowchart illustrating operations and processes that may be performed for customer controlled management of shipments. FIGS. 5-14, 15A, 15B, 16-18, 19A, 19B, 20-25, 26A, 26B, 27, and 28 show exemplary input and output for customer controlled management of shipments.

### 1. Registration

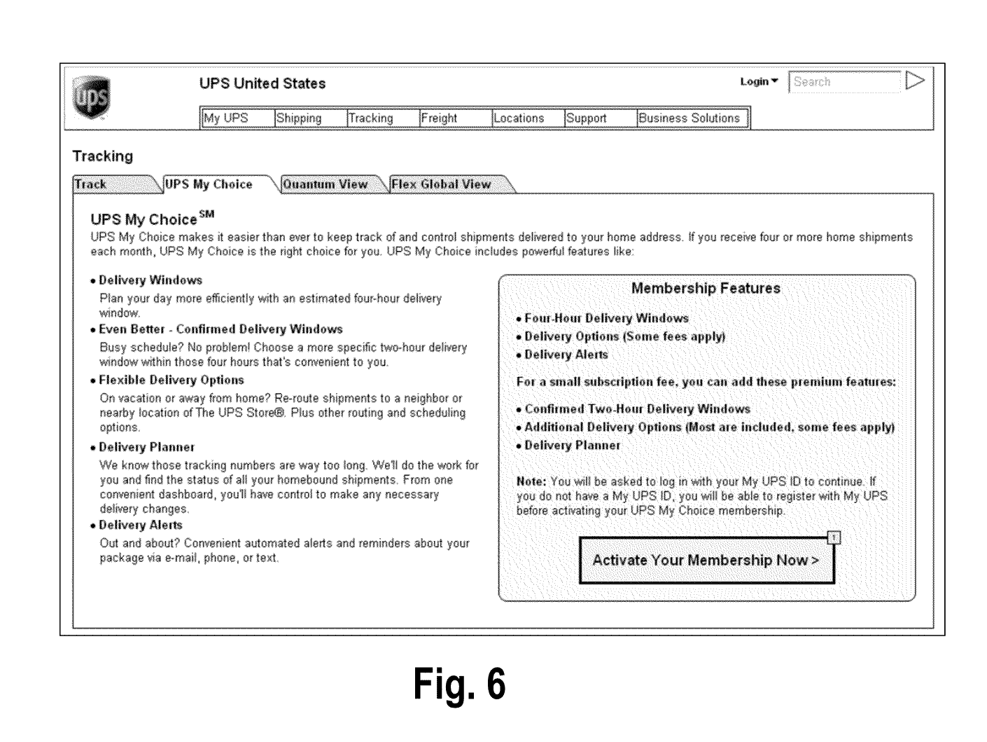

In one embodiment, as indicated in Block 400 of FIG. 4, the process may begin with the enrollment/registration of one or more customers (e.g., consignors and/or consignees) for a customer pickup, delivery, and/or returns program. A customer (e.g., consignor, consignee, third party, and/or the like) may be an individual, a family, a company, an organization, an entity, a department within an organization, a representative of an organization and/or person, and/or the like. To register, a customer (e.g., a customer or customer representative operating a consignee computing device 110 or consignor computing device 120) may access a webpage, application, dashboard, browser, or portal of a carrier, such as United Parcel Service of America, Inc. (UPS). For instance, as shown in FIGS. 5 and 6, the carrier system 100 may transmit a webpage that provides the customer with an option of logging into a customer account or enrolling/registering for a customer pickup, delivery, and/or returns program.

In one embodiment, as part of the enrollment/registration process, the customer (e.g., operating a consignee computing device 110 or consignor computing device 120) may be requested to provide biographic and/or geographic information by the carrier system 100 (e.g., via the registration module 270). Such information may be manually input or provided by allowing access to other accounts, such as Facebook, Gmail, Twitter, PayPal, and/or the like. For instance, the customer may provide the customer's name, such as a first name, a last name, a company name, an entity name, and/or an organization name. The customer (e.g., consignor or consignee) may also provide any aliases associated with the customer. For instance, if the customer (e.g., consignor or consignee) were an individual named Joseph Brown, the customer (e.g., consignor or consignee) may provide Joe Brown or Joey Brown as aliases.

The customer (e.g., consignor or consignee) may also provide one or more physical addresses associated with the customer (e.g., street address, city, state, postal code, and/or country) to the carrier system 100. For instance, Joseph Brown's primary residential address of 105 Main Street, Atlanta, Ga. 30309, USA, may be provided to the carrier system 100. Further, one or more secondary residential addresses may also be provided to the carrier system 100 for association with Mr. Brown's account and profile, such as 71 Lanier Islands, Buford, Ga. 30518, USA. As will be recognized, the residential addresses may include weekend residences, family member residences visited by the customer, and/or the like. Additionally, the customer (e.g., consignor or consignee) may also provide one or more business addresses associated with the customer (e.g., street address, city, state, postal code, and/or country) to the carrier system 100. For example, Mr. Brown may have a primary business address of 1201 W Peachtree, Atlanta, Ga. 30309, USA. One or more secondary business addresses may also be provided to the carrier system 100 for association with Mr. Brown's account and profile, such as 101 South Tryon Street, Charlotte, N.C. 28280, USA; 950 F Street, NW, Washington, D.C. 20004, USA; and 90 Park Avenue, New York, N.Y. 10016, USA. As will be recognized, the business addresses may include various office locations for a single enterprise, multiple office locations for various enterprises, and/or the like. As will be recognized, the customer (e.g., consignor or consignee) may provide other biographic and/or geographic information to adapt to various needs and circumstances.

In one embodiment, once the carrier system 100 receives the necessary biographic and/or geographic information from the customer, the carrier system 100 may perform one or more validation operations. For example, the carrier system 100 may determine whether the primary address (and/or other addresses) in the specified country or postal code is eligible for a customer pickup, delivery, and/or returns programs. The carrier system 100 may also determine whether the primary address (and/or other addresses) is valid, e.g., by passing the primary address through one or more address cleansing or standardization systems. The carrier system 100 may perform a variety of fraud prevention measures as well, such as determining whether the customer (e.g., consignor or consignee) or one of the customer's addresses has been “blacklisted” from customer pickup, delivery, and/or returns programs. As will be recognized, a variety of other approaches and techniques can be used to adapt to various needs and circumstances.

In one embodiment, the carrier system 100 may create a customer profile for the customer via the enrollment/registration process. Accordingly, the carrier system 100 may create and store various customer profiles (e.g., via database 240). In addition to at least the information described above, a customer profile may include one or more corresponding usernames and passwords. As will be recognized, each of the physical addresses may be associated with the customer's profile.

In one embodiment, in addition to the physical addresses, the customer (e.g., operating a customer computing device 110/120) may also input, request, or be automatically generated and assigned a “virtual address.” The virtual address can be a combination of alphanumeric characters to identify a customer or customer profile. The virtual address can be stored by the carrier system 100 in association with the customer's profile. For example, Joseph Brown (e.g., operating a customer computing device 110/120) may input a request for a unique virtual address such as BigBrown8675309 or any other unique virtual address. In another embodiment, the carrier system 100 may automatically generate and assign a unique virtual address for the customer, such as assigning virtual address 1XR457 to Joseph Brown. Such virtual addresses can be used by customers who do not want to (a) provide their physical addresses to merchants or other third parties, (b) have their physical addresses printed on labels placed on the exterior of items, and/or (c) the like. For instance, this may enable a consignor to ship a package using only BigBrown8675309 or 1XR457 as the destination address (e.g., virtual address) using the appropriate carrier. Upon induction of the package into the carrier's transportation and logistics network, the carrier personnel can read (e.g., manually or with the aid of a device) the virtual address on the item (e.g., BigBrown8675309 or 1XR457), look up the appropriate physical delivery address for the item based on the consignee's profile (e.g., search for the customer profile associated with the virtual address), and route the item accordingly (including the use of automatic service schedules). In certain embodiments, the item may be routed only using the virtual address. That is, each item the item is handled by carrier personnel, a mobile station 105 (in communication with the carrier system 100) operated by the carrier personnel can cause display of the appropriate handling or routing instructions while masking the actual physical delivery address. In other embodiments, however, once the item with the virtual address is inducted into the carrier's transportation and logistics network, carrier personnel may place a label on the item that indicates the physical delivery address (e.g., based on an address associated with the profile and/or automatic service schedule). Such virtual address concepts are disclosed in U.S. Pat. No. 8,108,321, which is hereby incorporated in its entirety by reference. Both physical addresses and virtual addresses may be referred to herein interchangeably as “addresses.”

In addition to the virtual address, the carrier system 100 may also generate and store an internal customer identifier in association with the customer profile. In one embodiment, a customer identifier may be used to uniquely identify a customer profile. In another embodiment, a customer identifier may be used to uniquely identify a given address (e.g., physical address or virtual address) associated with a customer profile. In such an embodiment, if a customer profile is associated with four addresses, the carrier system 100 may generate and store four customer identifiers in association with the customer profile (or use one customer identifier for all the addresses for the customer). The customer identifier may also be stored in association with shipping data for an item to associate the item (and its shipping data) with the (a) correct customer (e.g., customer profile) and/or (b) correct address for a customer.

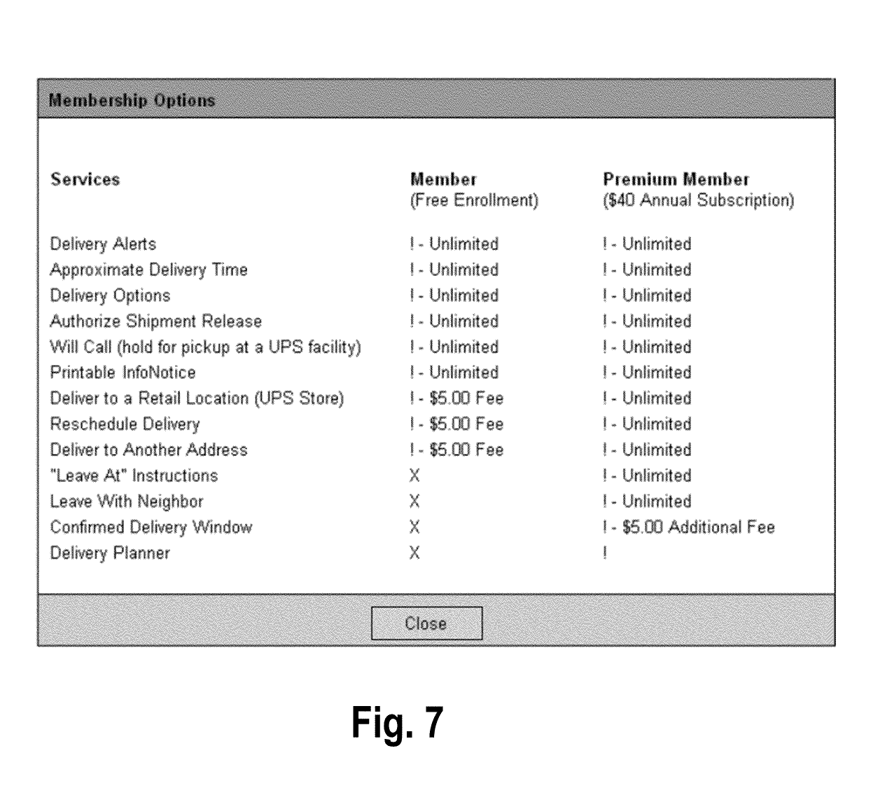

In one embodiment, a customer profile may correspond to one or more customer pickup, delivery, and/or returns programs. For instance, a customer (e.g., operating a customer computing device 110/120) may subscribe to a specific customer pickup, delivery, and/or returns program. In one embodiment, there may be several customer pickup, delivery, and/or returns programs from which to choose, such as a free customer pickup, delivery, and/or returns program and a premium customer pickup, delivery, and/or returns program. Each customer delivery program may have different benefits, such as those shown in FIG. 7 and Table 1 below.

As shown in Table 1 above and in FIG. 7 for illustrative purposes, the free customer pickup, delivery, and/or returns program and the premium customer pickup, delivery, and/or returns program may have different benefits. For example, the free customer pickup, delivery, and/or returns program may allow customers to have access to certain features, e.g., pickup and delivery alerts, approximate pickup and delivery times, change pickup and delivery options, electronically authorize the release of an item, and/or route items to will call. Similarly, the premium customer pickup, delivery, and/or returns program (e.g., requiring a fee) may allow customers to have access to certain features in addition to those provided via the free customer pickup, delivery, and/or returns program, e.g., route items to other retail locations, reschedule pickups and deliveries, request that items be delivered to another address, and/or provide instructions for pickup or delivery. Payments for such fees may be in a variety of forms, such as via debit card, credit card, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like. As will be recognized, these features are provided for illustrative purposes and are not limiting to embodiments of the present invention. Moreover, a variety of other approaches and techniques can be used to adapt to various needs and circumstances.

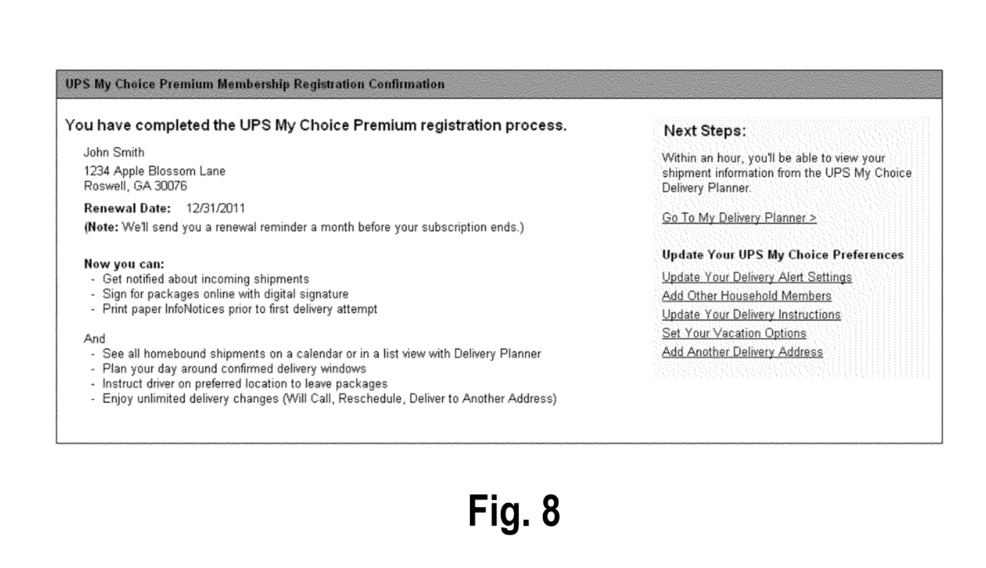

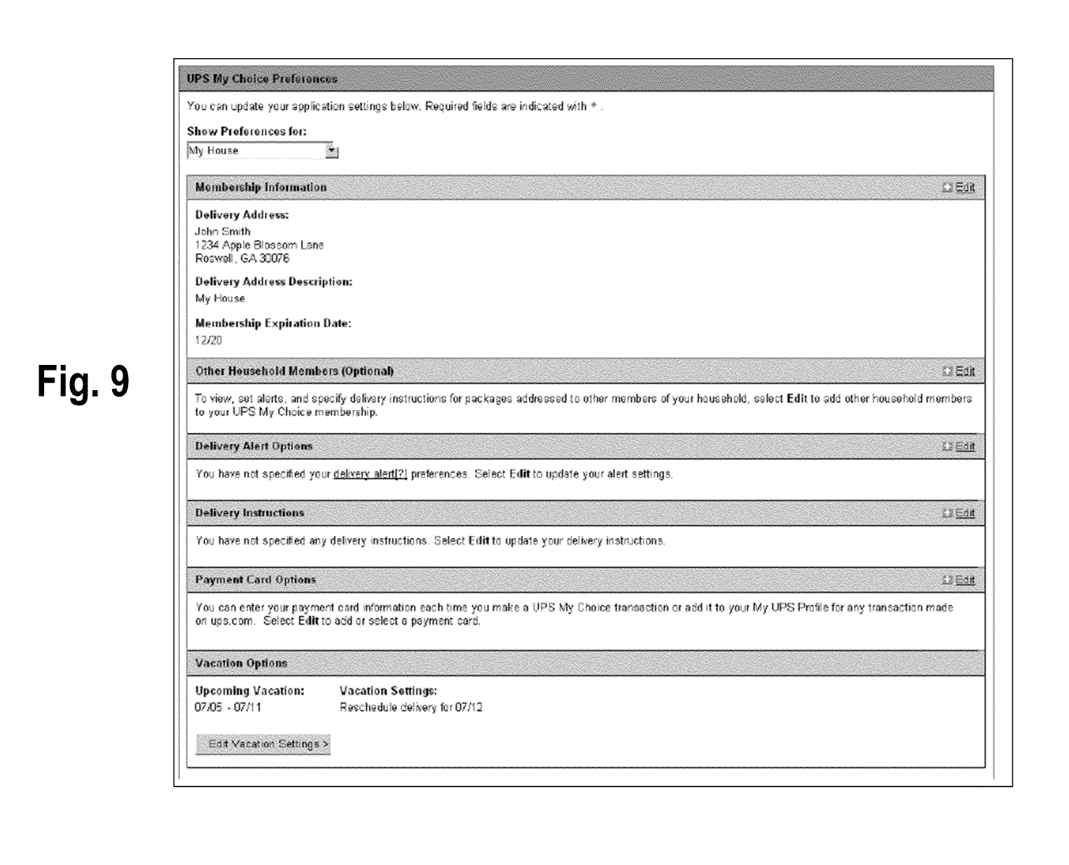

In one embodiment, once a customer profile has been created by the carrier system 100, the customer (e.g., operating a customer computing device 110/120) can provide various preferences associated with the customer delivery program to the carrier system 100 via a webpage (Block 405 of FIG. 4), for example. For instance, as shown in FIGS. 8 and 9, the customer (e.g., operating a customer computing device 110/120) can provide a variety of preferences, such communication preferences, service schedule preferences, delivery preferences, delivery options, and/or delivery instructions. The customer (e.g., operating a customer computing device 110/120) may also update any information through the appropriate interface (e.g., browser, dashboard, webpage, application).

### 2. Customer and Item Matching

In one embodiment, once a customer (e.g., consignor or consignee) profile has been created by the carrier system 100, one or more items to be picked up from, delivered to, and/or returned from the customer can be identified as corresponding to the customer. By identifying items corresponding to the customer, the carrier system 100 can provide the customer with access to various features of the customer pickup, delivery, and/or returns program. As will be recognized, an item may be one or more packages, parcels, bags, containers, loads, crates, items banded together, vehicle parts, pallets, drums, the like, and/or similar words used herein interchangeably. In one embodiment, each item may include an item/shipment identifier, such as an alphanumeric identifier. Such item/shipment identifiers (as well as physical and virtual addresses) may be represented as text, barcodes, Aztec Codes, MaxiCodes, Data Matrices, Quick Response (QR) Codes, electronic representations, and/or the like. The unique item/shipment identifier (e.g., 123456789) may be used by the carrier to identify and track the item as it moves through the carrier's transportation network. Further, such item/shipment identifiers can be affixed to items by, for example, using a sticker (e.g., label) with the unique item/shipment identifier printed thereon (in human and/or machine readable form) or an RFID tag with the unique item/shipment identifier stored therein.

In one embodiment, the carrier system 100 may store an item/shipment identifier in association with shipping data for the item. The shipping data may include information about the item, such as delivery service level. For example, the delivery service level may be Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like. The shipping data may include information about the party shipping the item (e.g., consignor), such as the party's address, the party's phone number, the party's return address, the party's name, and/or the like. The shipping data may also include information about the customer to whom the item is to be delivered (e.g., consignee), such as the customer's physical address or location (e.g., delivery point/location), the customer's virtual address, the customer's phone number, the customer's name, and/or the like. As will be recognized, the terms delivery point/location are intended encompass any identifiable location, including residences, commercial locations, stores, vehicles, boats, landmarks, and/or the like.

In one embodiment, the shipping data may include information about the item itself and any tracking information. The tracking information may reflect the item's movement in the carrier's transportation network, including an expected pickup or delivery date and time. To reflect the item's movement, an item/shipment identifier associated with the item may be scanned or otherwise electronically read at various points as the item is transported through the carrier's transportation network. For example, the item/shipment identifier may be automatically scanned by a barcode or MaxiCode device, an RFID interrogator, by a camera controller, or by a carrier employee using a handheld device (e.g., mobile station 105). In one embodiment, each time the item/shipment identifier is scanned or read, an appropriate device can transmit the item/shipment identifier and other appropriate information (e.g., location and time of the scan or reading) to the carrier system 100. The carrier system 100 can then receive and use the information to track the item as it is transported though the carrier's transportation network and update the shipping data accordingly.

In one embodiment, the carrier system 100 can use the shipping data to identify one or more customer profiles corresponding to the item (e.g., via the identification module 245). As described, each customer profile may include one or more physical addresses or virtual addresses associated with the customer. Thus, when the carrier system 100 receives shipping data (or a portion of shipping data) for an item (Block 410 of FIG. 4), the carrier system 100 can determine whether the item corresponds to any customers enrolled/registered for a customer pickup, delivery, and/or returns program. In particular, the carrier system 100 can use the physical delivery address or the virtual address of the intended recipient (e.g., consignee or customer) in the shipping data for an item to identify (a) any customer profiles with a substantially similar physical delivery address or (b) a customer profile that matches the virtual address (Block 415 of FIG. 4). For example, if the shipping data of an item indicates that the physical delivery address of the intended recipient is 105 Main St., Atlanta, Ga. 30309, the carrier system 100 may identify Joseph Brown's customer profile as corresponding to the item even though the address in Joseph Brown's profile is 105 Main Street, Atlanta, Ga. 30309, USA. In other words, in making such determinations, the carrier system 100 can accommodate variations for a given address. As will be recognized, the carrier system 100 may be configured to compensate for various discrepancies.

In one embodiment, as a secondary measure for matching physical addresses to customer profiles, the carrier system 100 can use the delivery name of the intended recipient (e.g., consignee or customer) in the shipping data to confirm that the identified customer profile is correct. To do so, the carrier system 100 may compare the delivery name of the intended recipient in the shipping data to the primary name and/or any aliases in the identified customer profile. If the names are substantially similar, the carrier system 100 can confirm that the identified customer profile is correct. By way of example, if the shipping data indicates that the delivery name of the intended recipient is Joe Brown and Joseph Brown listed Joe as a first name alias, the carrier system 100 could confirm Joseph Brown's customer profile as corresponding to the item. As will be recognized, a variety of other approaches and techniques can be used to identify a customer profile corresponding to at least one item to be delivered by the carrier.

In another embodiment, the carrier system 100 can use the virtual address of the intended recipient (e.g., consignee or customer) in the shipping data for an item to identify the appropriate customer profile (Block 415 of FIG. 4). For example, if the shipping data of an item indicates that the virtual address of the intended recipient is BigBrown8675309 (or 1XR457), for example, the carrier system 100 may identify Joseph Brown's customer profile as corresponding to the item. As will be recognized, a variety of other approaches and techniques can be used to adapt to various needs and circumstances.

In one embodiment, after identifying the appropriate customer profile for an item, the carrier system 100 can associate the shipping data with the customer profile (Block 420 of FIG. 4). In certain embodiments, this may include appending the shipping data with the appropriate customer identifier. For instance, the shipping data for all shipments corresponding to Joseph Brown's customer profile may be appended with the customer identifier created for Joseph Brown. In various embodiments, using this approach allows items (and their shipping data) to be linked to appropriate customer profiles. Thus, when Joseph Brown accesses his account, he can view all of his shipments (e.g., those shipments with shipping data appended with his customer identifier (or other identifier)). Similarly, any actions for an item or customer can be passed to the shipping data for the item (including carrying out automatic service schedules).

### 3. Item Tracking

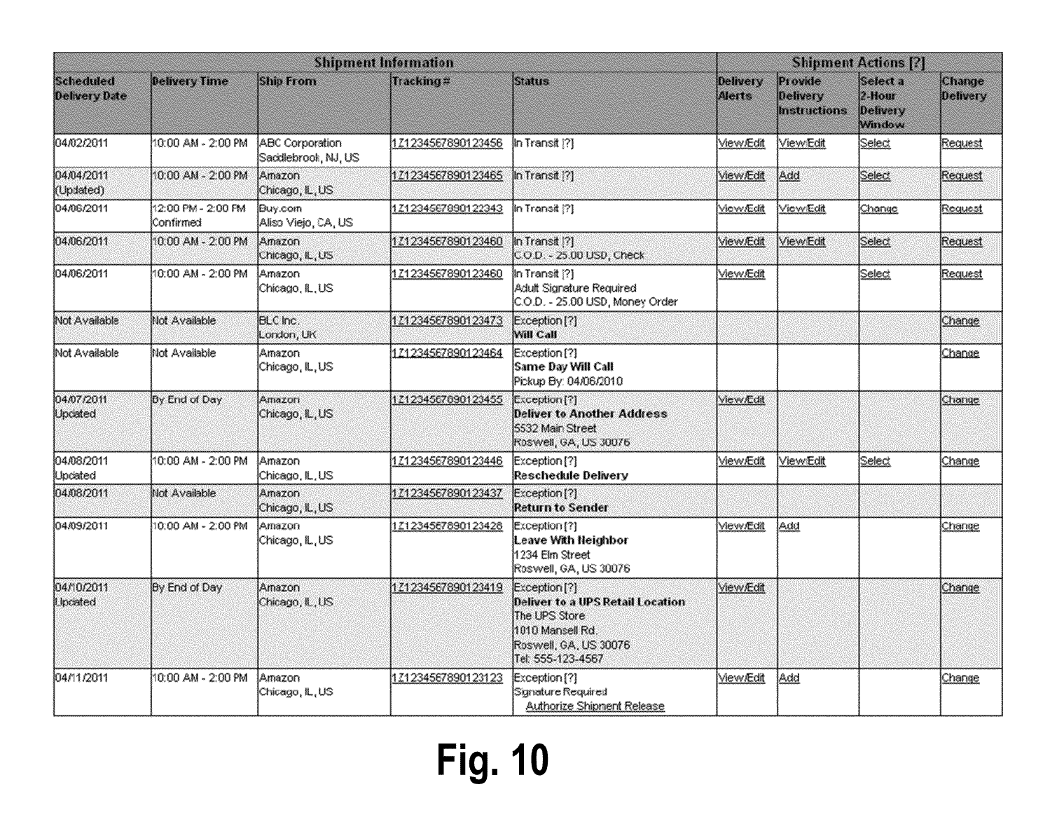

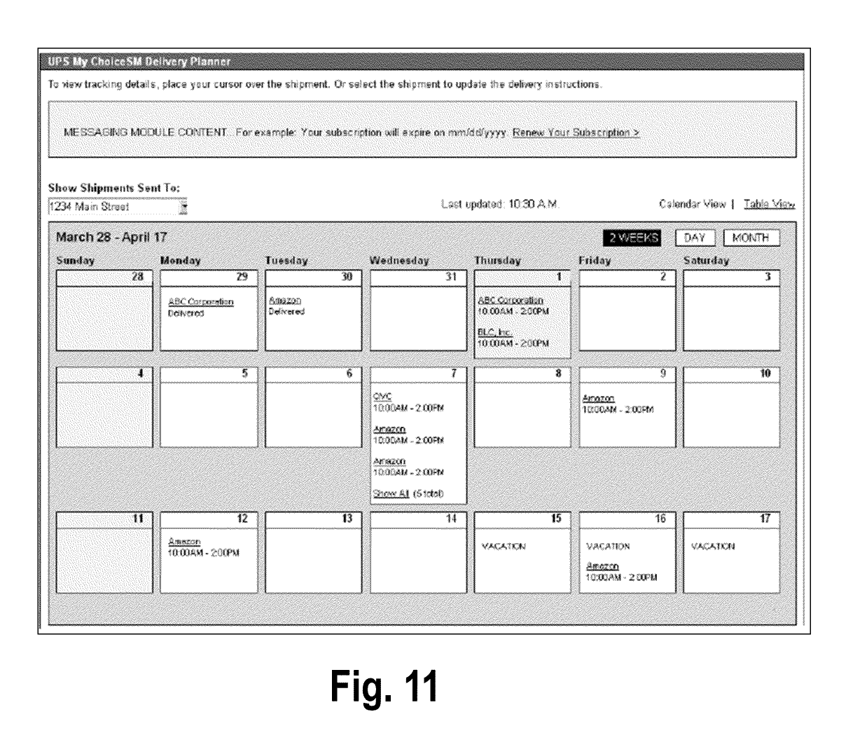

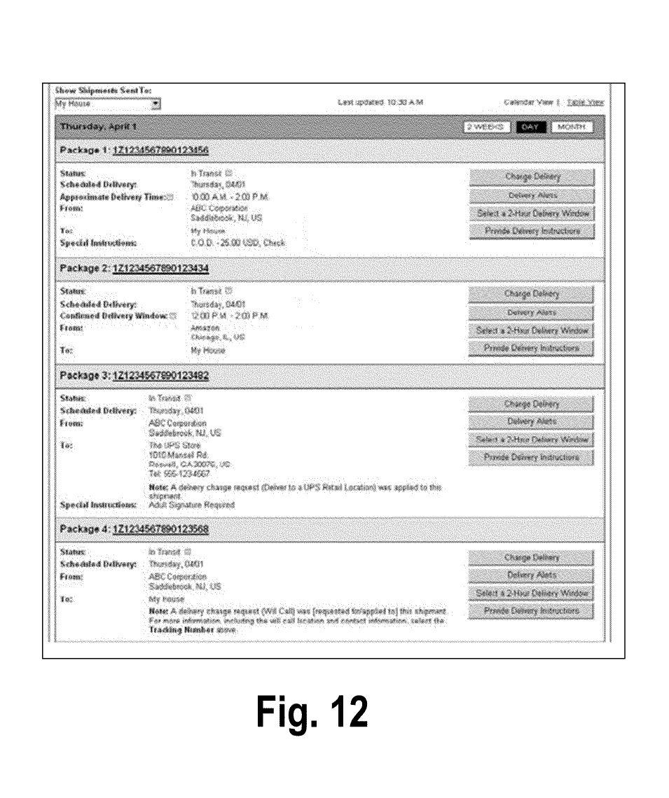

In one embodiment, by appending the shipping data with the appropriate customer identifier, the corresponding customer can view tracking information for any shipments associated with the customer profile. For instance, as shown in FIGS. 10-12, the carrier system 100 can be used to identify (e.g., retrieve the shipping data with the appropriate customer identifier) all shipments associated with a customer (e.g., customer profile) using the customer identifier and provide them to the customer for viewing in a customer-friendly format, such as via an interface (e.g., browser, dashboard, webpage, application). FIG. 10 shows an exemplary interface (e.g., browser, dashboard, webpage, application) with a list of all inbound shipments to a customer. FIG. 11 shows an interface with a calendar (which may have a day view, a week view, a multiple week view, and/or a month view) having a list of all inbound shipments to a customer. In FIG. 11, the calendar can be sorted by physical delivery address, indicating that the customer has more than one physical delivery address associated with the customer profile. FIG. 12 shows an interface (e.g., browser, dashboard, webpage, application) with a list of all inbound shipments to a customer. As will be recognized, a variety of other approaches and techniques can be used to adapt to various needs and circumstances, such as only displaying the deliveries for a defined time period (e.g., the past 90 days)

In various embodiments, these concepts can provide customers with ongoing visibility of all inbound packages (e.g., FIGS. 10, 11, and 12), as well as preferences, regardless of carrier. For instance, for each item, the interface (e.g., browser, dashboard, webpage, application) can be used to show the item/shipment identifier, a delivery indicator, a last activity scan date, a non-confirmed delivery window, a confirmed delivery window a commit time, whether an in-person signature is requested for delivery, a delivery service level, and/or various other information. Thus, through such an interface, customers (e.g., operating customer computing devices 110/120) can review and access all inbound shipments (from one or more carriers) using a single interface. As will be recognized, though, a variety of other approaches and techniques can be used to provide tracking information to a customer.

### 4. Messages/Alerts

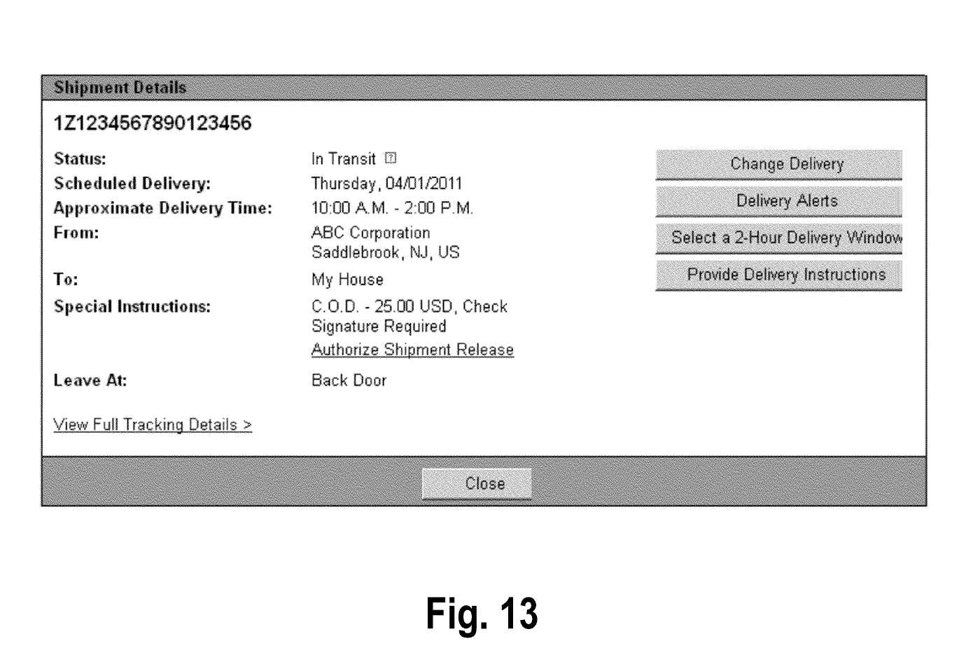

In one embodiment, customers (e.g., operating customer computing devices) can customize and/or provide communication preferences regarding items to be picked up from or delivered to the customers (shown in FIG. 13). For example, the communication preferences may provide customers with the ability to request messages for items before the carrier attempts to pick up or deliver items (e.g., prior to the first delivery attempt by the carrier) and/or after items have been picked up or delivered.

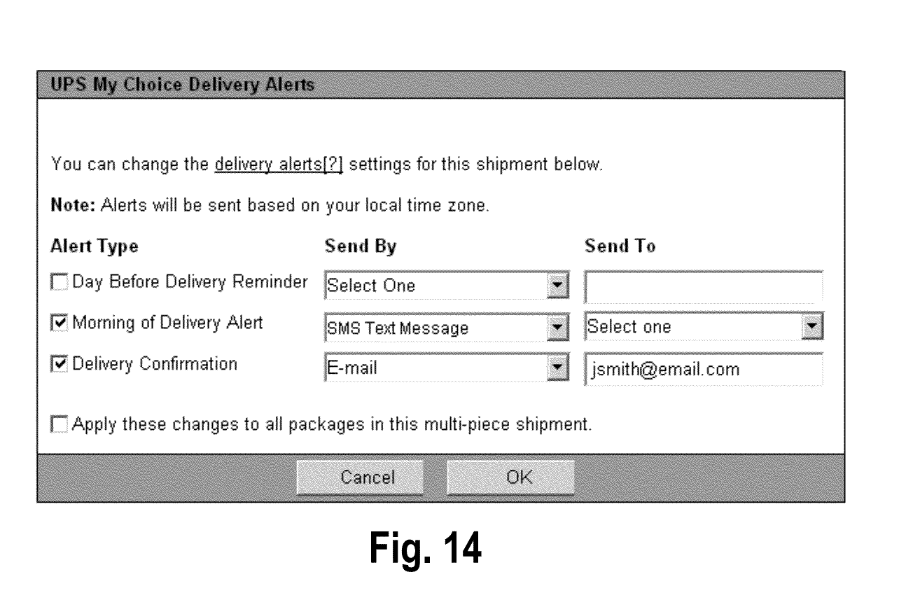

In one embodiment, as shown in FIG. 14, a customer (e.g., operating a consignee computing device 110 or consignor computing device 120) can identify one or more communication formats for communicating with the customer. The communication formats may include text messages (e.g., Short Message Service (SMS) and/or Multimedia Messaging Service (MMS), email messages, voice messages, video message (e.g., YouTube, the Vine), picture message (e.g., Instagram), social media message (e.g., private social media created internally for entities, business social media (e.g., Yammer, SocialCast), or public social media (e.g., Facebook, Instagram, Twitter)), and/or a variety of other messages in various communication formats. In addition to identifying one or more communication formats, the customer (e.g., operating a customer computing device 110/120) can identify the corresponding electronic destination addresses to be used in providing information regarding items to be picked up from or delivered to the customer. For instance, for text messages, the customer may provide one or more cellular phone numbers. For email messages, the customer may provide one or more email addresses. And for voice messages, the customer may provide one or more cellular or landline phone numbers. Additionally, in one embodiment, validation operations can be performed with respect to each input electronic destination address—to ensure their accuracy. As will be recognized, a variety of other types of electronic destination addresses can be used to adapt to various needs and circumstances.

In one embodiment, customers (e.g., operating a consignee computing device 110 or consignor computing device 120) may indicate the type of messages they want to receive (e.g., the content). For example, a customer may indicate that he only wants to receive messages when the shipping data for an item indicates that an in-person signature from the customer is requested for delivery of the item, when the pickup or delivery options for the item can be changed, when instructions for pickup or delivery of the item can be provided, or when the pickup or delivery service level of the item can be changed. In another example, a customer may indicate that he wants to receive messages for all items to be picked up from or delivered to the customer with expected dates and times. In yet another embodiment, a customer may indicate the he wants to receive messages for items that are automatically re-routed or when a fee will be assessed for delivering an item in accordance with the customer's automatic service schedule. As will be recognized, customers may indicate that they want to receive messages regarding items in a variety of other circumstances as well.

In one embodiment, customers (e.g., operating a consignee computing device 110 or consignor computing device 120) may identify/define time periods in which the messages providing information regarding items to be delivered should be transmitted to the customer. For instance, the time periods may include (a) after shipment and the day before an item is delivered and (b) after shipment and the morning of the day of delivery. In such cases, the messages can serve as a reminder to the customer that an item is being delivered. Similarly the time periods may be after delivery for confirmation of delivery or even after an unsuccessful delivery attempt to the customer. In such a case, the customer may define where and how messages regarding such unsuccessful delivery attempts should be made as part of the communication preferences or allow the carrier system 100 to track the customer for delivery after an unsuccessful attempt. As will be recognized, the carrier system 100 can store communication preferences for providing information in association with the customer profiles. Moreover, the communication preferences may apply to the customer profile globally, to selected customer addresses, to groups of items, and/or an item-by-item basis.

In one embodiment, the carrier system 100 may impose time constraints for placing, generating, and/or transmitting messages within the time periods identified by the customers. For example, the carrier system 100 may only transmit text messages to customers between 6:00 am-11:00 pm (based on time zones). Similarly, the carrier system 100 may place calls and transmit automated voice messages between 8:00 am-9:00 pm (based on time zones). And for email messages, the carrier system 100 may generate and transmit them without time constraints.

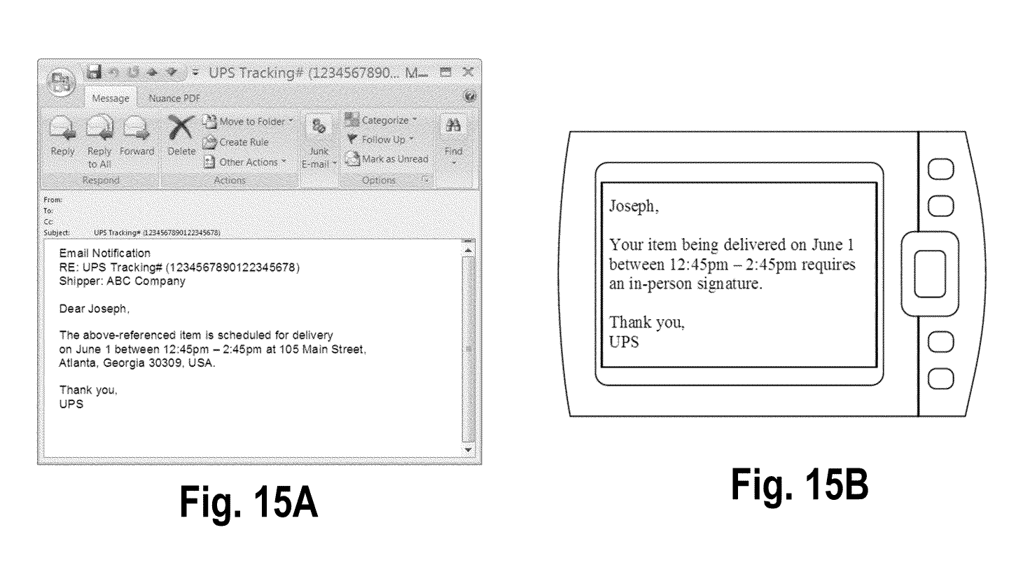

In one embodiment, the carrier system 100 can automatically generate (e.g., via the message module 260) one or more messages providing information regarding an item to be delivered to the customer (Block 425 of FIG. 4) in compliance with the customer's communication preferences and the carrier's time constraints. Similarly, the carrier system 100 can automatically transmit the one or messages to the electronic destination addresses in compliance with the customer's communication preferences and the carrier's time constraints. For example, the carrier system 100 may generate and transmit an email message to Joseph Brown's email address and a text message to Joseph's cellular phone the day before an item is to be delivered to Joseph's home address. The messages may indicate the expected delivery date and/or delivery time, such as shown in FIGS. 15A and 15B, and a variety of other information. As will be recognized, a variety of other operations and processes may be used with embodiments of the present invention. These operations and processes can be customized to adapt to various needs and circumstances.

### 5. Pickup/Delivery Times

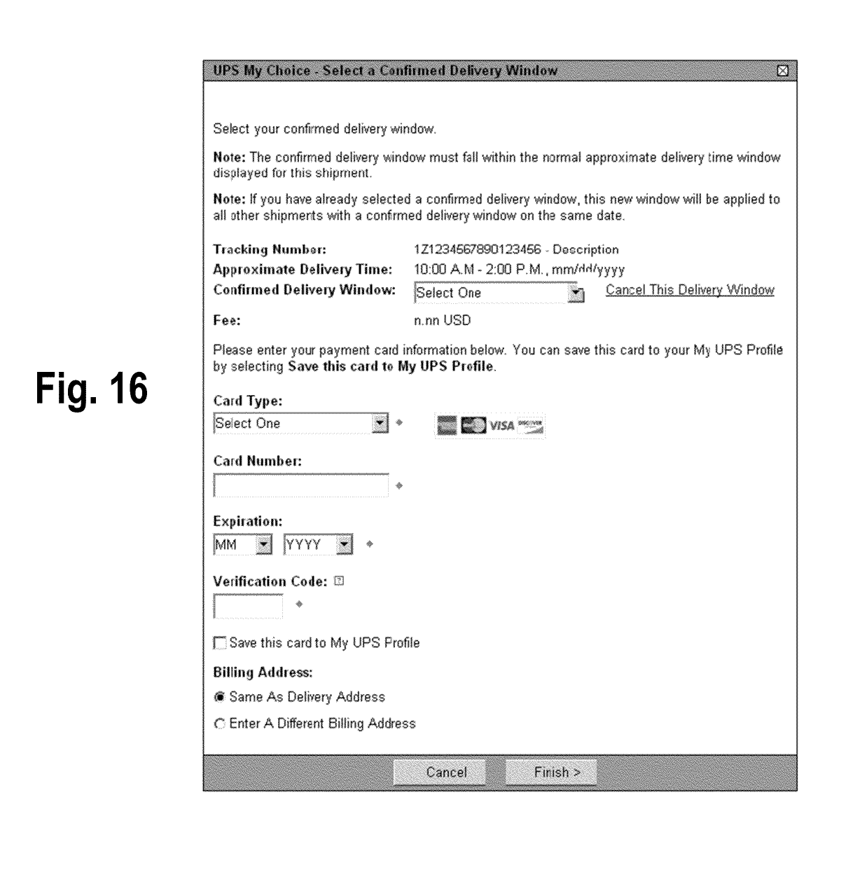

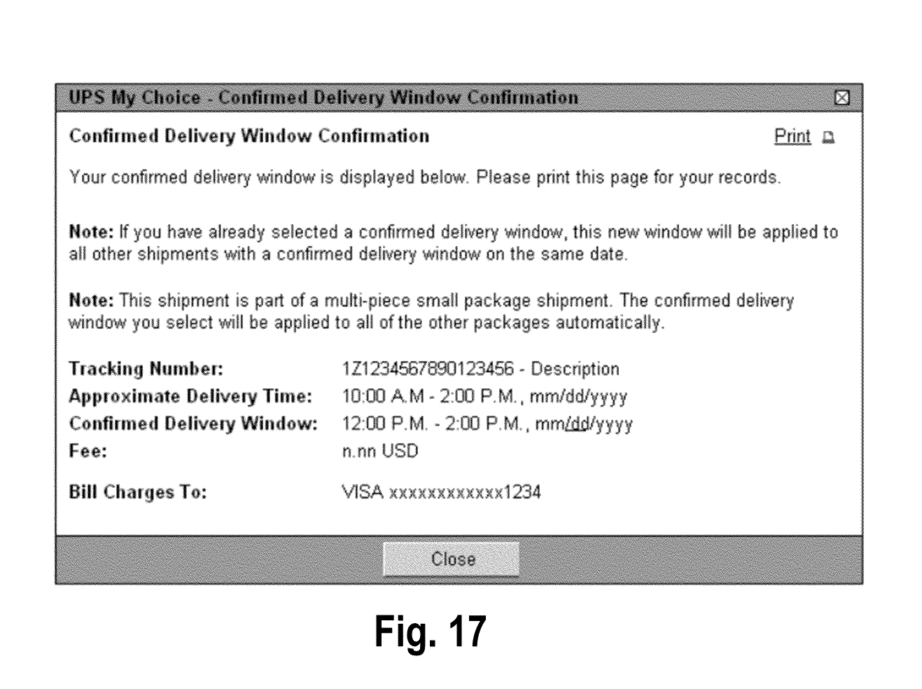

In one embodiment, the interface (e.g., browser, dashboard, application) can be used to view expected pickup or delivery times (estimate pickup or delivery windows and/or confirmed pickup or delivery windows) or determine/identify expected pickup or delivery times for use with automatic service schedules. In one embodiment, estimated time windows may indicate an estimated pickup or delivery time of an item based on historical pickup or delivery times to the area. Such information may be included in messages to customers prior to the first pickup or delivery attempt. As shown in FIG. 13, the interface (e.g., browser, dashboard, application) may also be used by the customer (e.g., operating an appropriate customer computing device 110/120) to request that items be delivered within a delivery window. That is, the customer may want an item delivered within a specific time window. The carrier may provide such services as part of a customer pickup, delivery, and/or returns program or on a fee basis, as shown in FIGS. 16 and 17. Table 2 below provides illustrative estimated pickup or delivery windows and confirmed pickup or delivery windows from which the customer can select to have an item picked up or delivered.

TABLE 2

| Estimated Windows | Confirmed Windows |
|---|---|
| 11:45 am-3:45 pm | 11:45 am-1:45 pm |
| | 12:45 pm-2:45 pm |
| | 1:45 pm-3:45 pm |
| 11:30 am-3:30 pm | 11:30 am-1:30 pm |
| | 12:30 pm-2:30 pm |
| | 1:30 pm-3:30 pm |
| 2:00 pm-5:45 pm | 2:00 pm-4:00 pm |
| | 3:45 PM-5:45 pm |
| 1:00 pm-4:15 pm | 1:00 pm-3:00 pm |
| | 2:15 pm-4:15 pm |
| 8:00 am-11:00 pm | 8:00 am-10:00 am |
| | 9:00 am-11:00 am |
| 3:00 pm-6:00 pm | 3:00 pm-5:00 pm |
| | 4:00 pm-6:00 pm |
| 3:00 pm-5:45 pm | 3:00 pm-5:00 pm |
| | 3:45 pm-5:45 pm |
| 4:00 pm-6:00 pm | 4:00 pm-6:00 pm |

Additional information regarding such time windows can be found in U.S. Pat. No. 6,701,299, U.S. Pat. No. 7,233,907, and U.S. Pat. No. 7,925,524, all of which are incorporated herein in their entireties by reference. As will be recognized, a variety of other operations and processes may be used with embodiments of the present invention. These operations and processes can be customized to adapt to various needs and circumstances.

### 6. Electronic Authorization for Item Release

In one embodiment, consignors, consignees, and/or the carrier may request that a recipient's signature be obtained at the point of delivery for certain items. In-person signature requests may be for high-value and/or high-risk items, such as cellular phones, computers, narcotic medications, and/or a variety of other items. Similarly, in-person signature requests may be designated by the carrier for items being delivered in non-driver release areas. A non-driver release area may be an area in which items have been stolen after being left at the delivery point/location (e.g., not delivered to a person) and/or for various other reasons. The following describes two separate approaches for delivering such packages without in-person signatures.

### A. Electronic Authorization for Item Release

In one embodiment, items that are shipped with a request for an in-person signature at the point of delivery may have a non-driver release status. The non-driver release status may be indicated in the shipping data. For example, the shipping data for an item may indicate that an in-person signature from a recipient (e.g., customer or representative of the customer) is requested for delivery of the item. In one embodiment, such information may be displayed via the interface (e.g., browser, dashboard, webpage, application) (shown in FIG. 13). For instance, the shipping data for the item represented in FIG. 13 indicates that an in-person signature is requested for delivery of the item. In addition to an in-person signature, in this example, payment of $25.00 is also needed for delivery.

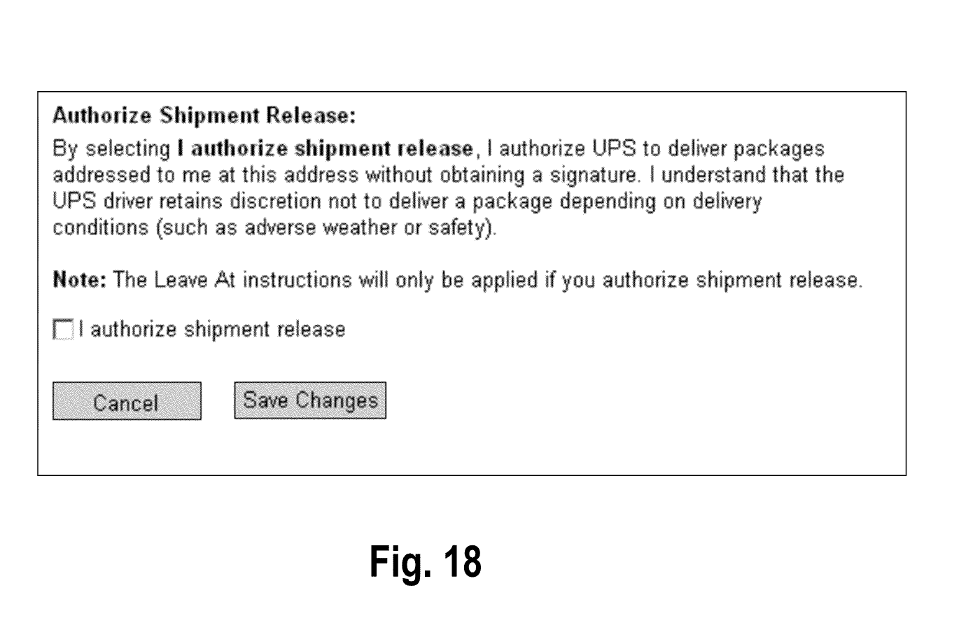

In one embodiment, the customer (e.g., operating a customer computing device 110/120) may electronically authorize delivery of the item without an in-person signature. To do so, the customer (e.g., operating a customer computing device 110/120) may electronically authorize release of the item without an in-person signature through the interface (e.g., browser, dashboard, webpage, application) in communication with the carrier system 100, for example. Operatively, in one embodiment, the customer (e.g., operating a customer computing device 110/120) may select a hyperlink (e.g., shown in FIG. 13) that reads “Authorize Shipment Release.” After (e.g., in response to) the carrier system 100 receives the request to authorize shipment release, the carrier system 100 can provide the appropriate information via the interface (e.g., browser, dashboard, webpage, application) for the customer. For instance, as shown in FIG. 18, the carrier system 100 may provide an interface (e.g., browser, dashboard, webpage, application displayed via a customer computing device 110/120) that provides a disclaimer for delivering the item without an in-person signature (e.g., delivering the item by leaving it at a front door of a house). The interface (e.g., browser, dashboard, webpage, application) may require the customer to check a box, type in his name, and/or perform other affirmative steps. The appropriate customer computing device 110/120 can then transmit the input authorization to the carrier system 100. The carrier system 100 can then receive the input authorization to deliver the item without an in-person signature (Block 430 of FIG. 4). After (e.g., in response to) receiving the authorization, the carrier system 100 can update the shipping data to reflect that the item can now be delivered without an in-person signature at the point of delivery.

In certain embodiments, an electronic authorization may have the same effect as an in-person signature at the point of the delivery. Such authorizations may be provided prior to the first delivery attempt by the carrier, further streamlining carrier operations and increasing customer satisfaction.

In addition to providing for electronic authorization to release items, the carrier system 100 can provide for payment of items so that cash-on-delivery items do not require an in-person transaction for delivery. As will be recognized, a variety of other operations and processes may be used with embodiments of the present invention. These operations and processes can be customized to adapt to various needs and circumstances.

### B. Automatic Electronic Authorization for Item Release

In one embodiment, an interface (e.g., browser, dashboard, application) in communication with the carrier system 100 can be used to automatically authorize delivery of items without in-person signatures even when the corresponding shipping data indicates that in-person signatures are requested for delivery. For example, the customer (e.g., operating a consignee computing device 110 or consignor computing device 120) may access the interface (e.g., browser, dashboard, application) in communication with the carrier system 100 to provide authorization to allow all (or select) items to be delivered without in-person signatures even when the corresponding shipping data indicates that in-person signatures are requested for delivery.

Operatively, in one embodiment, the customer (e.g., operating a consignee computing device 110 or consignor computing device 120) may select a hyperlink that reads “Authorize All Shipment Release.” After (e.g., in response to) the carrier system 100 receives the request to authorize the release of all (or select) items, the carrier system 100 can provide the appropriate information via the interface (e.g., browser, dashboard, application) for the customer. For instance, as shown in FIG. 18, the carrier system 100 may provide an interface (e.g., browser, dashboard, application displayed via a consignor/consignee computing device) that provides a disclaimer for delivering the items without in-person signatures (e.g., delivering the item by leaving it at a front door of a house). The interface (e.g., browser, dashboard, application) may require the customer to check a box, type in his name, and/or perform other affirmative steps to properly acknowledge consent. The appropriate customer computing device 110/120 can then transmit the input authorization to the carrier system 100. The carrier system 100 can then receive the input authorization to deliver the items without in-person signatures (Block 430 of FIG. 4). After (e.g., in response to) receiving the authorization, the carrier system 100 can update the customer profile to reflect that the items with corresponding shipping data indicating that in-person signatures are requested for delivery can be delivered without in-person signatures. This feature can be configured for items that have yet to be purchased, shipped, or delivered (e.g., for future transactions).

Thus, when an item to be delivered to the customer is matched to the customer profile and has corresponding shipping data indicating that an in-person signature is requested for delivery, the carrier system 100 can automatically change the corresponding shipping data to reflect that the item can be delivered without an in-person signature (e.g., based on the customer profile). In certain embodiments, this may require applying a new item/shipment identifier and/or label. For example, the carrier system 100 can transmit updated shipping data indicating that the item can be delivered without an in-person signature to the appropriate mobile stations 105 (and/or other computing entities). In one embodiment, the appropriate mobile stations 105 (and/or other computing entities) can receive the updated shipping data. Then, when carrier personnel sorting items or loading delivery vehicles, for example, scan the unique item/shipment identifier (e.g., using a mobile station 105), the mobile station 105 can provide the carrier personnel with an indication that the item can be delivered without an in-person signature. This may include indicating that a new label (and/or item/shipment identifier) needs to be affixed to the item. The item can then be transported and delivered with the new label by the carrier and delivered without requiring an in-person signature.

In another embodiment, this feature may also require that items satisfy certain criteria in order to automatically allow an item to be delivered without an in-person signature. For example, the customer may indicate that only items originating from identified consignors (e.g., Amazon, Lands' End, William Robinson, etc.) can be delivered without in-person signatures. In this example, customer Joseph Brown can update his customer profile such that all items to be delivered to him that originate from Lands' End are to be delivered without in-person signatures. Thus, as described above, in this example, all items to be delivered to Joseph Brown originating from Lands' End can be delivered without in-person signatures (if they were originally requested). As will be recognized, a variety of other approaches and techniques can be used to adapt to various needs and circumstances, such as requiring that the items be of a specific delivery service level, scheduled for delivery on a particular day of the week, and/or the like.

### 7. Instructions for Pickup or Delivery

In one embodiment, pickup or delivery personnel working for a carrier (and other carrier personnel) may carry and operate mobile stations 105 to assist in the pickup or delivery of items. For example, shipping data (or at least a portion of shipping data) corresponding to items to be picked up or delivered can be transmitted regularly, periodically, continuously, and/or on demand to the appropriate mobile stations 105. Thus, for instance, carrier personnel can scan an item/shipment identifier on an item (e.g., using a mobile station 105 in communication with the carrier system 100) to view information about the pickup or delivery of the item. The mobile station 105 may also be used to provide instructions for pickup or delivery to carrier personnel. The instructions may include information, such as where an item should be left at a delivery point/location and/or access codes needed to pick up or deliver an item. The pickup or delivery person can also use the mobile station 105 to record information about the pickup or delivery of the item, such as where and at what time the item was picked up or delivered.

In one embodiment, an interface (e.g., browser, dashboard, application) in communication with the carrier system 100 (e.g., via the delivery options module 250) can be used to provide instructions regarding items to be picked up from or delivered to customers (e.g., prior to a delivery attempt by the carrier). For example, the customer (e.g., operating a consignee computing device 110 or consignor computing device 120) may access the interface (e.g., browser, dashboard, application) to view items to be delivered. The interface (e.g., browser, dashboard, application) may also provide the customer with the option of providing instructions for delivering one or more items and in accordance with one or more automatic service schedules.

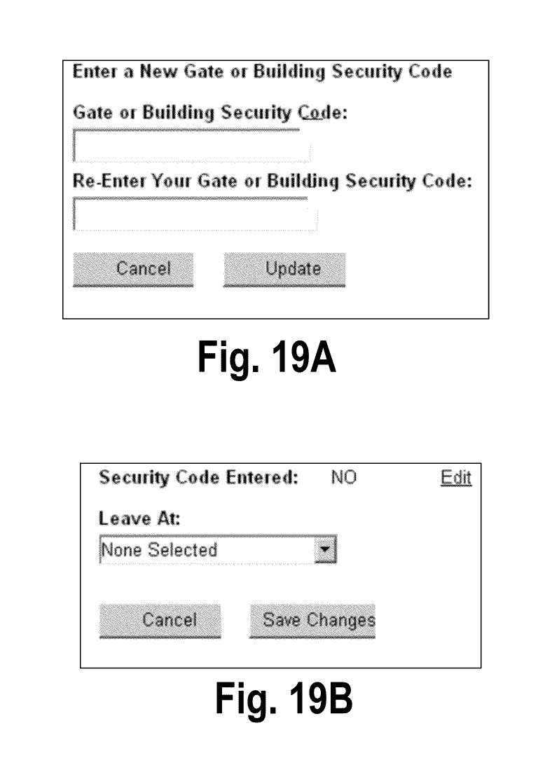

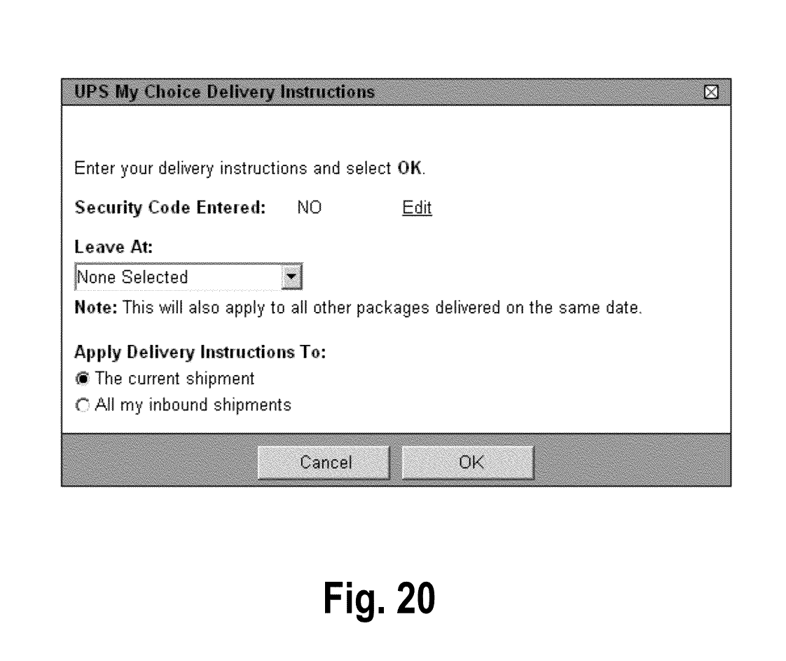

In one embodiment, to provide such instructions, the customer (e.g., operating a consignee computing device 110 or consignor computing device 120) may select a button (e.g., shown in FIG. 13) that reads “Provide Delivery Instructions.” After (e.g., in response to) the carrier system 100 receives the request to provide instructions, the carrier system 100 can provide the information to the customer via an appropriate interface (e.g., browser, dashboard, application). For instance, as shown in FIGS. 19A, 19B, and 20, the carrier system 100 may provide an interface (e.g., browser, dashboard, application) to the customer (e.g., displayed via an appropriate customer computing device 110/120) that provides the ability to input one or more instructions for using a code to enter an area proximate the pickup or physical delivery address, such as building codes, door codes, and/or gate codes. The carrier system 100 may also provide an interface (e.g., browser, dashboard, application) to the customer (e.g., displayed via an appropriate customer computing device 110/120) that provides the ability to input one or more instructions that identify a location at the physical delivery address at which the item should be left. Table 3 below provides illustrative instructions and corresponding codes.

TABLE 3

| Leave-At Instructions | Optional |
|---|---|
| Leave at-Front Door | Security Code to Access Front Door |
| Leave at-Rear Door | Security Code to Access Rear Door |
| Leave at-Side Door | Security Code to Access Side Door |
| Leave at-Garage | Security Code to Access Garage |
| Leave at-Porch | Security Code to Access Porch |
| Leave at-Deck | Security Code to Access Deck |
| Leave at-Patio | Security Code to Access Patio |
| Leave at-Reception | Security Code to Access Reception |
| Leave at-Management Office | Security Code to Access Office |
| Leave at-Door Person | Security Code to Reach Door Person |
| Leave at-Neighbor | Security Code for Neighbor |

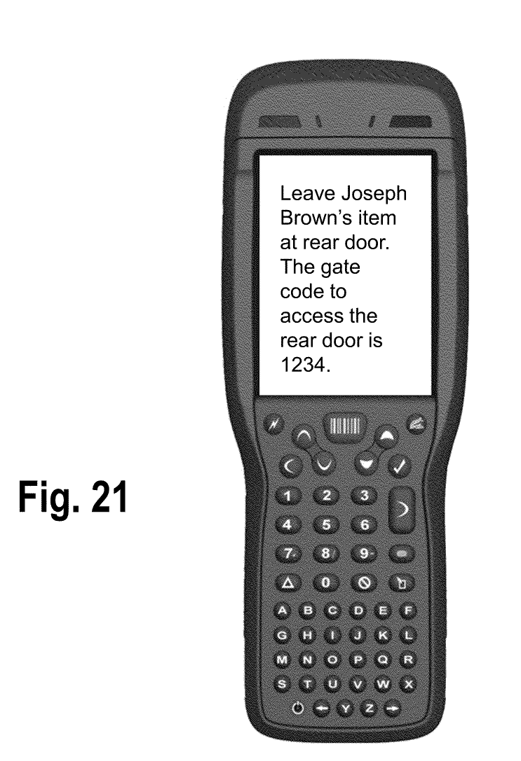

In one embodiment, as indicated in Block 435 of FIG. 4, the carrier system 100 can receive the one or more instructions for delivery (e.g., before a first delivery attempt). After (e.g., in response to) receiving the one or more instructions for delivery, the carrier system 100 can update the shipping data to reflect that the item should be delivered in accordance with the one or more instructions. The updated shipping data (or at least a portion of updated shipping data) can be transmitted regularly, periodically, continuously, and/or on demand by the carrier system 100 to the appropriate mobile stations 105. The appropriate mobile station 105 can receive the updated shipping data (or at least a portion of updated shipping data). Then, a delivery person can scan an item/shipment identifier on an item (e.g., using a mobile station 105) to view information about the delivery of the item, and the updated shipping data (or at least a portion of updated shipping data) can be displayed, including the one or more instructions for delivery. The delivery person can then deliver the item in accordance with the one or more instructions for delivery. For instance, as shown in FIG. 21, the instructions may be to leave an item at a rear door at a delivery point/location and further provide a gate code needed to access the rear door. A variety of other instructions for pickup or delivery can be provided as well.

As will be recognized, the one or more instructions for pickup or delivery may apply to the customer profile globally (e.g., providing that all items be delivered in accordance with the instructions), to selected customer addresses (e.g., physical addresses and virtual addresses), to groups of items, and/or an item-by-item basis. As indicated, such instructions may be provided prior to the first delivery attempt by the carrier. Moreover, a variety of other operations and processes may be used with embodiments of the present invention. These operations and processes can be customized to adapt to various needs and circumstances. For instance, the carrier may include such services as part of a customer pickup, delivery, and/or returns program and/or require a fee.

### 8. Pickup/Delivery Options

In one embodiment, as described, shipping data (or at least a portion of shipping data) corresponding to items to be picked up or delivered can be transmitted regularly, periodically, continuously, and/or on demand by the carrier system 100 to the appropriate mobile stations 105. Thus, for instance, carrier personnel can scan an item/shipment identifier on an item (e.g., using a mobile station 105) to view, access, provide, and/or retrieve information about the item or pickup or delivery of the item. In one embodiment, shipping data can be updated to change pickup or delivery options, such as changing the pickup or delivery point/location, the pickup or delivery date, the pickup or delivery time, and/or the pickup or delivery service level.

### A. Non-Vacation Options

In one embodiment, an interface (e.g., browser, dashboard, application) in communication with the carrier system 100 (e.g., via the delivery options module 250) can be used to change delivery options regarding items to be delivered to customers (e.g., prior to a delivery attempt by the carrier). For example, the customer (e.g., operating a consignee computing device 110 or consignor computing device 120) may access the interface (e.g., browser, dashboard, application) in communication with the carrier system 100 to view items to be picked up or delivered. The interface (e.g., browser, dashboard, application) may provide the customer with the option of changing pickup or delivery options for one or more items.

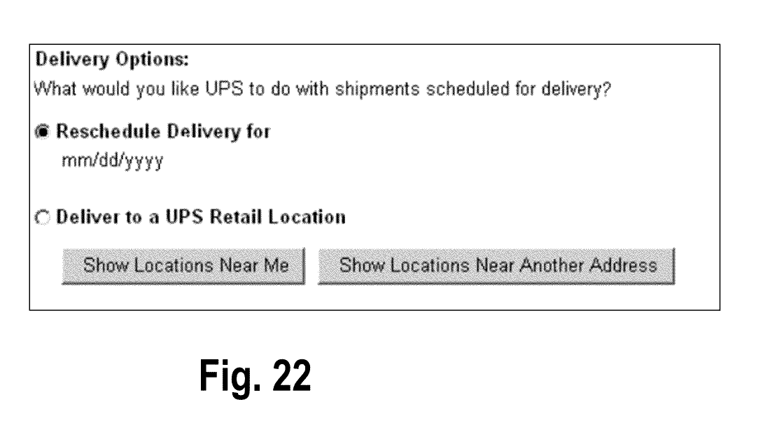

In one embodiment, to change delivery options, the customer (e.g., operating a consignee computing device 110 or consignor computing device 120) may select a button, icon, link, or graphic (e.g., shown in FIG. 13) that reads “Change Delivery.” After (e.g., in response to) the carrier system 100 receives the request to change delivery options, the carrier system 100 can provide the information to the customer via an appropriate interface (e.g., browser, dashboard, application). For instance, as shown in FIG. 22, the carrier system 100 may provide an interface (e.g., browser, dashboard, application) to the customer (e.g., displayed via an appropriate customer computing device 110/120) that provides the ability to change delivery options. The delivery options may allow the customer to request to have the item held at a carrier facility for pick up (e.g., will call or same day will call). The delivery options may allow the customer to request to reschedule delivery of the item for another date and/or time (e.g., a future date and time). The delivery options may allow the customer to change the delivery service level of the item (e.g., change the delivery service level from Ground to 2nd Day Air or Ground to SurePost) after the item has been shipped. In one embodiment, this may allow for the item to be delivered earlier than initially indicated (e.g., both date and time). The delivery options may allow the customer request to change the delivery point/location to a carrier facility (or other location), such as a UPS Store. And the delivery options may allow the customer to request to return the item to the consignor. As will be recognized, embodiments of the present invention may also allow a customer to change a variety of other delivery options.

In one embodiment, as indicated in Block 435 of FIG. 4, the carrier system 100 can receive the changed delivery options as input from the customer. After (e.g., in response to) the changed delivery options, the carrier system 100 can accept the requested changes (e.g. including validating the changes). The carrier system 100 can then update the shipping data to reflect that the item should be delivered in accordance with the changed delivery options. In one embodiment, the change in delivery options may require applying a new item/shipment identifier and/or label. For example, as described, the updated shipping data (or at least a portion of updated shipping data) corresponding to items to be delivered can be transmitted regularly, periodically, continuously, and/or on demand by the carrier system 100 to the appropriate mobile stations 105 (and/or other computing entities).

In one embodiment, the appropriate mobile stations 105 (and/or other computing entities) can receive the updated shipping data (or at least a portion of updated shipping data) corresponding to items to be delivered. Thus, carrier personnel sorting items or loading delivery vehicles can scan an item/shipment identifier (e.g., using a mobile station 105) on an item to view information about the delivery of the item, and the updated shipping data (or at least a portion of updated shipping data) can be displayed. The updated shipping data may indicate that a new label (and/or item/shipment identifier) needs to be affixed to the item (e.g., the new label may indicate the new physical delivery address). The item can then be delivered in accordance with the changed delivery options.

In various embodiments, the carrier may include such services as part of a customer pickup, delivery, and/or returns program and/or require a fee. As indicated, in one embodiment, the delivery options may be changed prior to the first delivery attempt by the carrier. Moreover, a variety of other operations and processes may be used with embodiments of the present invention. These operations and processes can be customized to adapt to various needs and circumstances.

### B. Vacation Options

In one embodiment, an interface (e.g., browser, dashboard, application) in communication with the carrier system 100 (e.g., via the delivery options module 250) can be used to change delivery options regarding items to be delivered to customers while the customers are on vacation (or otherwise away from the delivery point/location, such as being out of town on a business trip). For example, a customer (e.g., operating a consignee computing device 110 or consignor computing device 120) may access the interface (e.g., browser, dashboard, application) in communication with the carrier system 100 to input delivery options while the customer is on vacation.

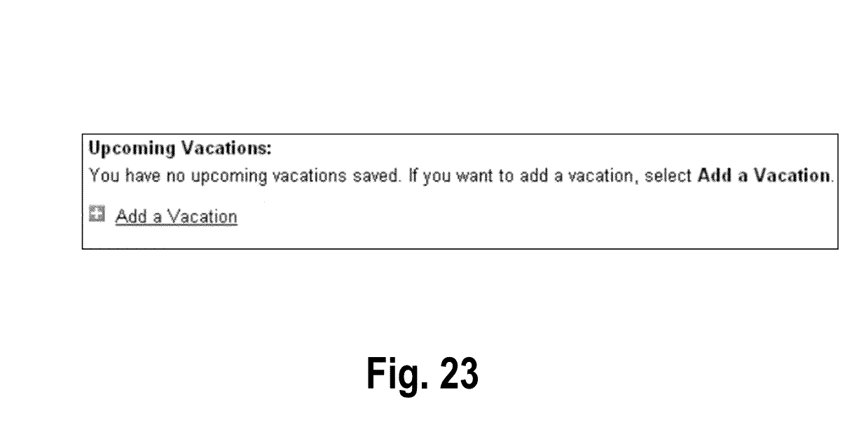

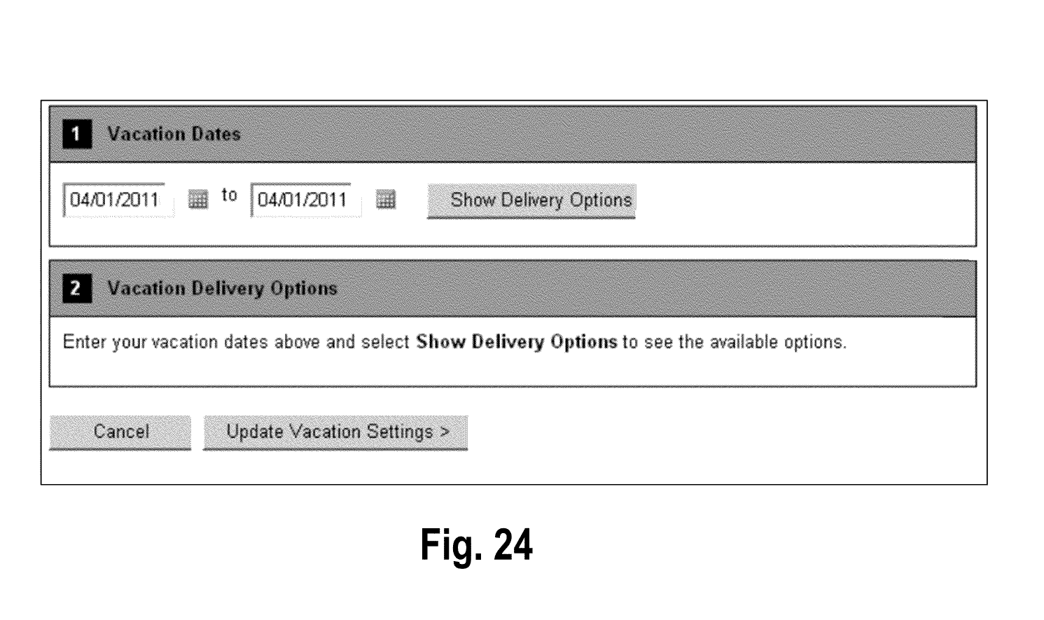

In one embodiment, to input such delivery options, the customer (e.g., operating a consignee computing device 110 or consignor computing device 120) may select a button, icon, link, or graphic (e.g., shown in FIG. 23) that reads “Add a Vacation.” After (e.g., in response to) the carrier system 100 receives the request to add a vacation, the carrier system 100 can provide the information to the customer via an appropriate interface (e.g., browser, dashboard, application). For instance, as shown in FIGS. 24, 25, 26A, and 26B, the carrier system 100 may provide an interface (e.g., browser, dashboard, application) to the customer (e.g., displayed via an appropriate customer computing device 110/120) that provides the ability to input vacation dates and/or delivery options (e.g., the delivery point/location, the delivery date, and/or the delivery time). During the vacation time period, the delivery options may allow the customer to request to have items held at a carrier facility for will call or to be automatically rescheduled for delivery on another date or at the end of the vacation option. Similarly, during the vacation time period, the delivery options may allow the customer to request to have all items delivered to a carrier facility for later pick up, such as a UPS Store.

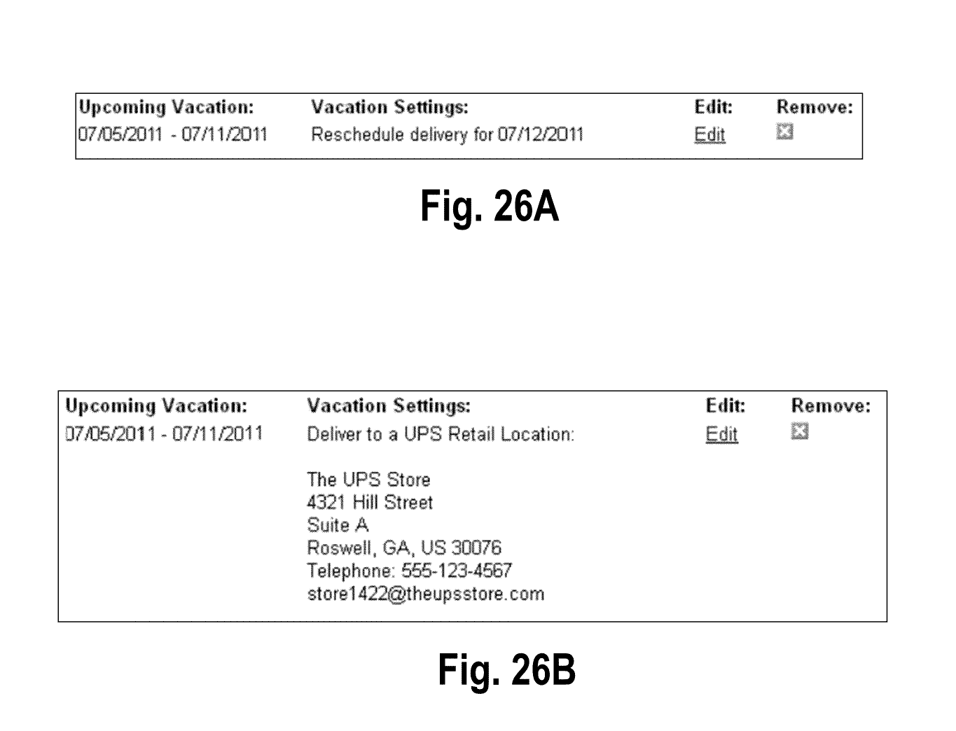

In one embodiment, as indicated in Block 435 of FIG. 4, the carrier system 100 can receive the input vacation dates and/or delivery options. After (e.g., in response to) receiving the input vacation dates and/or delivery options, the carrier system 100 can apply the vacation delivery options to all items to be delivered to the customer (and/or one of the customer's physical addresses in his customer profile) during the vacation time period. For instance, as shown in FIG. 26A, all items to be delivered to a customer between Jul. 5, 2011 and Jul. 11, 2011 can be rescheduled for delivery on Jul. 12, 2011. Similarly, as shown in FIG. 26B, all items to be delivered to a customer between Jul. 5, 2011 and Jul. 11, 2011 can be delivered to a carrier facility (such as a UPS Store) for later pickup by the customer. In one embodiment, vacation options may require applying a new label (and/or item/shipment identifier) to items to be delivered during the vacation time period.

### C. Change in Pickup or Delivery Service Level

In one embodiment, an interface (e.g., browser, dashboard, application) in communication with the carrier system 100 can be used to change pickup or delivery service levels for items to be picked up from or delivered to customers. For example, the customer (e.g., operating a consignee computing device 110 or consignor computing device 120) may access the interface (e.g., browser, dashboard, application) in communication with the carrier system 100 to view items to be delivered. The interface (e.g., browser, dashboard, application) may provide the customer with the option of changing the delivery service levels for one or more items (e.g., change the delivery service level from Ground to 2nd Day Air or from Ground to SurePost).

In one embodiment, to change the delivery service level for an item, the customer (e.g., a customer or customer representative operating a consignee computing device 110 or consignor computing device 120) may select a button, icon, link, or graphic (similar to FIG. 13, although not shown in FIG. 13) that reads “Change Service Level.” After (e.g., in response to) the carrier system 100 receives the request to change the delivery service level, the carrier system 100 can provide the appropriate information via the interface (e.g., browser, dashboard, application) to the customer. For instance, the carrier system 100 may be in communication with an interface (e.g., browser, dashboard, application displayed via a consignor/consignee computing device) that provides the ability to change the delivery service level. For example, this may allow the customer to change the delivery service level from SurePost to Ground, from Ground to 2nd Day Air, from 2nd Day Air to Next Day Air, from 2nd Day Air to Ground, and/or the like. Thus, the delivery service level can be changed from a first delivery service level with which it was originally shipped to a second delivery service level (after the item has been shipped but) prior to the first delivery attempt of the item. In one embodiment, this may allow for the item to be delivered earlier or later than initially indicated (e.g., both date and time).

In one embodiment, as indicated in Block 435 of FIG. 4, the carrier system 100 can receive the request to change the delivery service level as input from the customer. After (e.g., in response to) receiving such a request, the carrier system 100 can accept the requested changes (e.g. including validating the changes). The carrier system 100 can then update the shipping data to reflect that the item should be delivered in accordance with the second (e.g., changed) delivery service level, which may automatically change the delivery date and/or cost associated with delivering the item. In one embodiment, the change in the delivery service level may require applying a new item/shipment identifier and/or label. For example, as described, the updated shipping data (or at least a portion of updated shipping data) corresponding to items to be delivered can be transmitted regularly, periodically, continuously, and/or on demand by the carrier system 100 to the appropriate mobile stations 105 (and/or other computing entities).

In one embodiment, the appropriate mobile stations 105 (and/or other computing entities) can receive the updated shipping data (or at least a portion of updated shipping data) corresponding to items to be delivered. Thus, carrier personnel sorting items or loading delivery vehicles can scan an item/shipment identifier (e.g., using a mobile station 105) on an item to view information about the delivery of the item, and the updated shipping data (or at least a portion of updated shipping data) can be displayed. The updated shipping data may indicate that a new label (and/or item/shipment identifier) needs to be affixed to the item (e.g., the new label may indicate the new delivery service level). The item can then be transported and delivered with the new label by the carrier in accordance with the second (e.g., changed) delivery service level.

In various embodiments, the carrier may include such services as part of a customer pickup, delivery, and/or returns program and/or require a fee on a transaction basis. As indicated, in one embodiment, the delivery options may be changed prior to the first delivery attempt by the carrier. Moreover, a variety of other operations and processes may be used with embodiments of the present invention. For example, changing the delivery service level feature can be used in conjunction with other features described herein, such as customer and item matching features, item tracking features, messaging features, delivery time features, electronic authorization for item release features, instructions for delivery features, and/or delivery option features. Thus, these operations and processes can be customized to adapt to various needs and circumstances.

### D. Automatic Change in Delivery Service Level

In one embodiment, an interface (e.g., browser, dashboard, application) in communication with the carrier system 100 can be used to automatically change pickup or delivery service levels for items to be picked up from or delivered to customers. For example, the customer (e.g., a customer or customer representative operating a consignee computing device 110 or consignor computing device 120) may access the interface (e.g., browser, dashboard, application) in communication with the carrier system 100 to view delivery service level options for items that have yet to be purchased, shipped, or delivered. In one embodiment, the interface (e.g., browser, dashboard, application) may provide the customer with the option of automatically changing the delivery service level for all (or select) items to be delivered via a specific delivery service level (e.g., Next Day Air, Next Day Air Early AM, Next Day Air Saver, 2nd Day Air, 2nd Day Air Early AM, 3 Day Select, Ground, and/or SurePost).

In one embodiment, to automatically change the delivery service level for all (or select) items to be delivered via a specific delivery service level, the customer (e.g., a customer or customer representative operating a consignee computing device 110 or consignor computing device 120) may select a button, icon, link, or graphic that reads “Automatic Service Level Change.” After (e.g., in response to) the carrier system 100 receives the request to automatically change delivery service levels, the carrier system 100 can provide the appropriate information via the interface (e.g., browser, dashboard, application) to the customer. For instance, the carrier system 100 may be in communication with an interface (e.g., browser, dashboard, application displayed via a consignor/consignee computing device) that provides the ability to set automatic delivery service level changes for all (or select) items to be delivered via the specific delivery service level. For instance, the customer can input that all (or select) items to be delivered via a first delivery service level (e.g., SurePost) should automatically be changed to a second delivery service level (e.g., Ground). Thus, this feature may allow the customer to automatically change the delivery service level for all items to be delivered via a first delivery service level to a second delivery service level (e.g., from SurePost to Ground, from Ground to 2nd Day Air, from 2nd Day Air to Next Day Air, from 2nd Day Air to Ground, and/or the like). Automatically changing delivery service levels may automatically change the delivery dates and/or costs associated with delivering the item. As indicated, this may even occur after the items have been shipped but prior to the first delivery attempt of the items.

In one embodiment, as indicated in Block 435 of FIG. 4, the carrier system 100 can receive the request to automatically change the delivery service level as input from the customer. After (e.g., in response to) receiving such a request, the carrier system 100 can accept the requested changes (e.g. including validating the changes). The carrier system 100 can then update the customer profile to reflect that items to be delivered in accordance with the first delivery service level (and/or from a specific consignor) should be automatically changed to a second delivery service level during transport by the carrier.

Thus, when an item to be delivered to the customer is matched to the customer profile and is to be delivered via the first delivery service level (e.g., SurePost), the carrier system 100 can automatically change the first delivery service level to the second delivery service level as reflected in the customer profile. As described, this may require applying a new item/shipment identifier and/or label. For example, the carrier system 100 can transmit regularly, periodically, continuously, and/or on demand to the appropriate mobile stations 105 (and/or other computing entities) that the first delivery service level (e.g., SurePost) should be changed to a second delivery service level (e.g., Ground) for the item. In one embodiment, the appropriate mobile stations 105 (and/or other computing entities) can receive the indication. Then, when carrier personnel sorting items or loading delivery vehicles, for example, scan the unique item/shipment identifier (e.g., using a mobile station 105), the mobile station 105 can provide the carrier personnel with an indication that the first delivery service level should be changed to the second delivery service level. This may include indicating that a new label (and/or item/shipment identifier) needs to be affixed to the item (e.g., the new label may indicate the new delivery service level). The item can then be transported and delivered with the new label by the carrier in accordance with the second (e.g., changed) delivery service level.

In another embodiment, this feature may also require that items satisfy other criteria in order to automatically change the delivery service level. For example, the customer may indicate that only items originating from identified consignors (e.g., Amazon, Lands' End, William Robinson, etc.) have their delivery service levels changed automatically. In this example, customer Joseph Brown can update his customer profile such that all items to be delivered to him that originate from Lands' End are to be automatically changed to the Second Day Air delivery service level (if not already Second Day Air). Similarly, customer Joseph Brown can update his profile such that all items originating from identified consignors (e.g., Amazon, Lands' End, William Robinson, etc.) and to be delivered via a first delivery service level (e.g., SurePost) have their delivery service level automatically changed to a second delivery service level (e.g., Ground). In this example, all items to be delivered to Joseph Brown via SurePost and originating from Lands' End can be automatically changed from the SurePost delivery service level to the Ground delivery service level. As will be recognized, a variety of other approaches and techniques can be used to adapt to various needs and circumstances.

In various embodiments, the carrier may include such services as part of a customer pickup, delivery, and/or returns program and/or require a fee on a transaction basis. As indicated, in one embodiment, the delivery options may be changed prior to the first delivery attempt by the carrier. Moreover, a variety of other operations and processes may be used with embodiments of the present invention. For example, changing the delivery service level feature can be used in conjunction with other features, such as customer and item matching features, item tracking features, messaging features, delivery time features, electronic authorization for item release features, instructions for delivery features, delivery option features, and/or the like. Thus, these operations and processes can be customized to adapt to various needs and circumstances, such as being used with automatic service schedules as is described in greater detail below.

### 9. Automatic Service Schedules

In one embodiment, an interface (e.g., browser, dashboard, application) in communication with the carrier system 100 can be used to create or configure customer-defined service schedules (also referred to herein as automatic service schedules, customer-defined delivery schedules, customer-defined pickup schedules, service schedules, and similar words used herein interchangeably) for items to be picked up from or delivered to customers (also referred to as pickup preferences, delivery preferences, customer-defined preferences, and/or similar words used herein interchangeably). Such service schedules may be based on a variety of factors, conditions, requirements, parameters, and/or similar words used herein interchangeably to indicate a customer's delivery preferences. For instance, through such automatic service schedules, customers may provide delivery preferences based on times of the day, days of the week, months of the year, delivery instructions, delivery service levels, seasons, consignors (e.g., the automatic service schedule may only apply to items being shipped from specific consignors as described previously for delivery service levels), holidays for the pickup or delivery date/time (e.g., Thanksgiving, Christmas, Yom Kippur, etc.), weather conditions for the pickup or delivery date/time (e.g., 60% chance of rain, day time highs above 75°, sunny, etc.), travel conditions for the pickup or delivery date/time (e.g., traffic congestion, road closures, etc.), environmental conditions for the pickup or delivery date/time (e.g., smog, air quality, pollen count, etc.), safety conditions for the pickup or delivery date/time (e.g., National Terrorism Advisory System (NTAS) threat levels, travel advisories, etc.), travel itineraries, social network activity (e.g., internal, Yammer, SocialCast, Facebook, Twitter, Instagram, the Vine, and/or the like—including those previously described), predictive schedules (e.g., Google Now, Cue, Osito, Tempo Al, Dark Sky), and/or the like. For example, a customer may configure an automatic service schedule for pickups or deliveries using any variety of factors to indicate his or her preferences, such as preferring/requesting delivery of items at a beach house during the summer when the day time highs on delivery dates are expected to be above 75°, but to a home address otherwise. In another example, a customer may configure an automatic service schedule to prefer/request delivery to a home address instead of a business address based on traffic conditions for the pickup or delivery date/time, road closures for the pickup or delivery date/time, pollen levels for the pickup or delivery date/time, air quality readings for the pickup or delivery date/time or NTAS threat levels for the pickup or delivery date/time. As will be recognized, a variety of other approaches and techniques can be used to adapt to various needs and circumstances in customizing such service schedules.

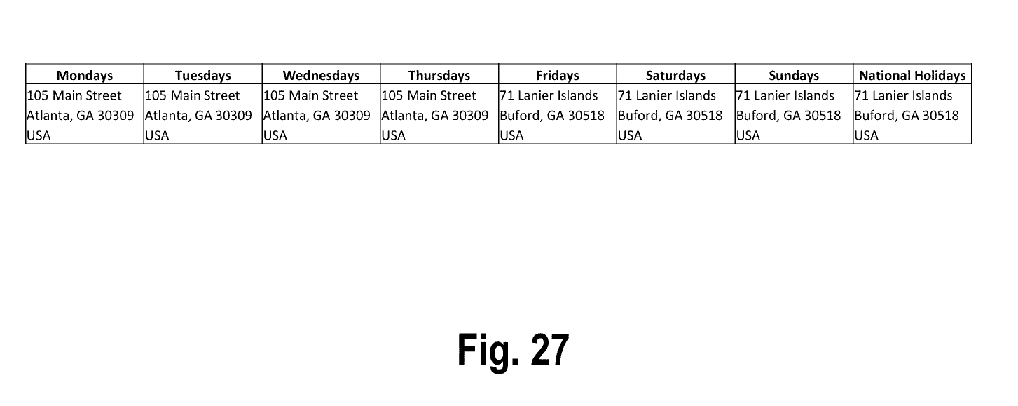

In one embodiment, an automatic service schedule can be created or configured for a given customer profile, a physical address, a virtual address, a person at a physical address, and/or the like. To create or configure an automatic service schedule, a customer (e.g., operating a consignee computing device 110 or consignor computing device 120) may access an interface (e.g., browser, dashboard, application) in communication with the carrier system 100. In doing so, the customer may navigate to an appropriate area and input or select from various service schedule options provided by or available through the carrier system 100. For example, as shown in FIG. 27, a customer (e.g., operating a consignee computing device 110 or consignor computing device 120) may provide a physical address to which items should be delivered for each day of the week (including holidays). Continuing with the above example, pickups from or deliveries to Joseph Brown on Mondays, Tuesdays, Wednesdays, and Thursdays should be made at 105 Main Street, Atlanta, Ga. 30309, USA. However, pickups from or deliveries to Joseph Brown on Fridays, Saturdays, Sundays, and national holidays should be made at 71 Lanier Islands, Buford, Ga. 30518, USA. After receiving the input for the automatic service schedule preferences/requests (e.g., provided by a customer operating an appropriate computing device 110/120), the carrier system 100 can update the appropriate customer profile to reflect that items to be picked up from and/or delivered to the customer should be in accordance with the service schedule. Such automatic services schedules can be used to deliver items in accordance with the preferences regardless of the physical address to which the item is originally addressed or intended to be delivered.

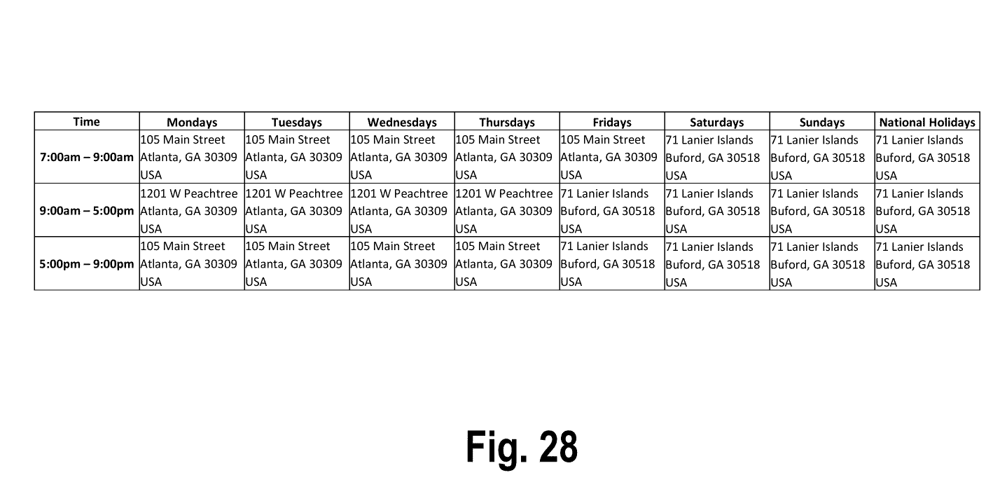

In another example, as shown in FIG. 28, a customer (e.g., operating a consignee computing device 110 or consignor computing device 120) may provide a physical address to which items should be delivered for each day of the week (including holidays) and for certain time periods during those days. Continuing with the above example, pickups from or deliveries to Joseph Brown on Mondays, Tuesdays, Wednesdays, and Thursdays (a) between 7:00 am-9:00 am and 5:00 pm-9:00 pm should be made at 105 Main Street, Atlanta, Ga. 30309, USA, and (b) between 9:00 am-5:00 pm should be made at 1201 W Peachtree, Atlanta, Ga. 30309, USA. Pickups from or deliveries to Joseph Brown on Fridays (a) between 7:00 am-9:00 am should be made at 105 Main Street, Atlanta, Ga. 30309, USA, and (b) between 9:00 am-9:00 pm should be made at 71 Lanier Islands, Buford, Ga. 30518, USA. And pickups from or deliveries to Joseph Brown on Saturdays, Sundays, or national holidays should be made at 71 Lanier Islands, Buford, Ga. 30518, USA. After receiving the input for the automatic service schedule (e.g., provided by a customer operating an appropriate computing device 110/120), the carrier system 100 can update the appropriate customer profile to reflect that items to be picked up from and/or delivered to the customer should be in accordance with the service schedule (e.g., the customer's preferences or requests). As noted, such service schedules may be based on other considerations, factors, criteria, and similar words used herein interchangeably as well, such as months of the year, delivery instructions, delivery service levels, seasons, weather conditions for the pickup or delivery date/time, travel conditions for the pickup or delivery date/time, environmental conditions for the pickup or delivery date/time, safety conditions for the pickup or delivery date/time, and/or the like. Such automatic services schedules can be used to deliver items in accordance with the preferences regardless of the physical address, date, time, and/or the like that were originally intended by the consignor, carrier, or consignee.

After a service schedule has been created, configured, and/or updated, shipping data for an item can be matched to the customer profile when the item is to be delivered to the customer. The shipping data can be generated, received, accessed, and/or similar words used herein interchangeably upon receiving notification of the shipment, upon induction into the carrier's transportation and logistics network, at various scan or read points/locations within the carrier's transportation and logistics network, at the delivery point/location, and/or the like. The carrier system 100 can use such shipping data to identify one or more customer profiles corresponding to the item. For example, when the carrier system 100 receives shipping data (or a portion of shipping data) for the item, the carrier system 100 can determine whether the item corresponds to identify (a) any customer profiles with a substantially similar physical delivery address (including matching recipient names) or (b) a customer profile that matches the virtual address. Continuing with the above examples, if shipping data of an item indicates that the physical delivery address of the intended recipient is 105 Main Street, Atlanta, Ga. 30309, USA (or any of the other addresses associated with Joseph Brown), the carrier system 100 may identify Joseph Brown's customer profile (e.g., Joseph Brown) as corresponding to or being associated with the item. Similarly, if the shipping data for the item indicates that the virtual address of the intended recipient is BigBrown8675309 or 1XR457, the carrier system 100 may identify Joseph Brown's customer profile (e.g., Joseph Brown) as corresponding to or being associated with the item. As will be recognized, a variety of other approaches and techniques can be used to identify customers or their corresponding profiles to shipping data for items.

In one embodiment, with the appropriate customer profile identified for the item to be delivered, the carrier system 100 can determine whether the customer is associated with an automatic service schedule or identify the customer's automatic service schedule. If the customer does not have an automatic service schedule, the carrier system 100 can allow the item to be delivered without consideration of any customer-defined service schedules. However, if the customer does have an automatic service schedule (e.g., if the customer profile is associated with an automatic service schedule), the carrier system 100 can evaluate delivery of the item in accordance with the customer's defined automatic service schedule. Such an evaluation or determination may include evaluating various considerations, factors, and/or criteria, such as determining the month of the year for the delivery date/time, determining the season for the delivery date/time, determining/identifying the expected weather conditions for the delivery date/time, determining/identifying the expected travel conditions for the delivery date/time, determining/identifying the expected environmental conditions for the pickup or delivery date/time, safety conditions for the pickup or delivery date/time, and/or the like. Such determinations/evaluations/identifications can then be used to determine how the item should be processed, handled, routed, and/or delivered in accordance with the customer's automatic service schedule. Continuing with the above example, the carrier system 100 may determine to which physical address the item should be delivered based on the expected delivery date/time. The carrier system 100 may make this determination based on, for instance, the origin of the item, the delivery point/location (or based on the virtual address lookup), the corresponding delivery service level, the location of the item within the carrier's transportation and logistics network, congestion or delays within the carrier's transportation and delivery network, and/or the like.

In the examples previously described, assume a consignor shipped an item to Joseph Brown at 105 Main Street, Atlanta, Ga. 30309 (e.g., first delivery point) and that the carrier system 100 determines or estimates the expected delivery date to be Wednesday at 3:00 pm. For the item to be delivered in accordance with the automatic service schedule in FIG. 27 (e.g., the customer's delivery preferences), the item could be appropriately delivered to 105 Main Street, Atlanta, Ga. 30309. However, for the item to be delivered in accordance with the automatic service schedule in FIG. 28, the item would need to be re-routed and delivered to 1201 W Peachtree, Atlanta, Ga. 30309, for delivery on Wednesday at 3:00 pm or between 9:00 am-5:00 pm. In another example, if multiple items are en route to be delivered in accordance with an automatic service schedule, the carrier system 100 may direct each item to a different physical address even if delivery is to occur the same day (e.g., multiple delivery points for the same day). For instance, assume that two items are en route for delivery to Joseph Brown: (1) a first item to be delivered on Wednesday at 1201 W Peachtree, Atlanta, Ga. 30309, at 8:00 am and (2) a second item to be delivered on Wednesday at 105 Main Street, Atlanta, Ga. 30309, at 3:00 pm. For the items to be delivered in accordance with the automatic service schedule in FIG. 28, the first item would need to be re-routed and delivered to 105 Main Street, Atlanta, Ga. 30309, at the same time or between 7:00 am-9:00 am, and the second item would need to be re-routed and delivered to 1201 W Peachtree, Atlanta, Ga. 30309, at the same time or between 9:00 am-5:00 pm. Thus, if multiple items are en route to be delivered in accordance with the automatic service schedule, the carrier system 100 may direct each item to a different physical address even if delivery is to occur the same day (e.g., multiple delivery points for the same day). As will be recognized, a variety of other approaches and techniques can be used to adapt to various needs and circumstances.

To re-route an item, the carrier system 100 can update the shipping data to indicate that the item should be delivered (e.g., re-routed) to 1201 W Peachtree, Atlanta, Ga. 30309 (e.g., second delivery point). Then, carrier personnel sorting items or loading delivery vehicles can scan an item/shipment identifier (e.g., using a mobile station 105 in communication with the carrier system 100) on the item to view information about the delivery of the item. The carrier system 100 can transmit regularly, periodically, continuously, and/or on demand to the appropriate mobile stations 105 (and/or other computing entities) that the item should be re-routed (e.g., that the item should be delivered to the second delivery point instead of the first delivery point). Thus, the appropriate mobile stations 105 (and/or other computing entities) can receive the corresponding indications and/or updated shipping data. Thus, when carrier personnel sorting items or loading delivery vehicles, for example, scan the unique item/shipment identifier or virtual address (e.g., using a mobile station 105), the mobile station 105 can provide the carrier personnel with an indication and/or updated shipping data that the item should be re-routed (e.g., that the item should be delivered to the second delivery point instead of the first delivery point and/or that the delivery service level should be changed to meet the original time commitment). This may include indicating that a new label (and/or item/shipment identifier) needs to be affixed to the item (e.g., the new label may indicate the new delivery point/location and/or new delivery service level).

As will be recognized, automatic service schedules may require that the delivery service levels be automatically changed (as has been described in detail previously). For example, depending on the distance between delivery point/locations in a customer's automatic service schedule, the delivery service level for an item may need to be changed (e.g., from Ground to Next Day Air) based on the original expected delivery date and/or time. For instance, for an item originally shipped from Georgia to Florida via Ground that has been automatically re-routed to New York based on an automatic service schedule, the delivery service level will likely need to be changed to expedite the delivery and meet the original delivery date/time. Such a service level change may require additional fees to be paid by the customer to meet his or her delivery preferences. Further, the carrier system 100 may also provide messages to the appropriate customers as described above. As will be recognized, a variety of approaches and techniques can be used to adapt to various needs and circumstances.

In various embodiments, the carrier may include such automatic service schedules as part of a customer pickup, delivery, and/or returns program and/or require a fee on a transaction basis, and/or the like—such as requiring a fee for delivery service level changes or changing delivery points/locations. Moreover, a variety of other operations and processes may be used with embodiments of the present invention. For example, the automatic service levels feature may be used in conjunction with other features, such as customer and item matching features, changing the delivery service level features, item tracking features, messaging features, delivery time features, electronic authorization for item release features, instructions for delivery features, delivery option features, and/or the like. Thus, these operations and processes can be customized to adapt to various needs and circumstances.

### 10. Blocking Features

In one embodiment, an interface (e.g., browser, dashboard, webpage, application) (or other mechanism) in communication with the carrier system 100 can be used to block features from being used with a customer profile. The features that may be blocked include customer and item matching features, item tracking features, messaging features, delivery time features, electronic authorization for item release features, instructions for delivery features, delivery option features, and/or the like. To block such features, the customer (e.g., operating a customer computing device 110/120) may access the interface (e.g., browser, dashboard, webpage, application) in communication with the carrier system 100 to select the features he or she desires to block for the customer profile. This may be used, for example, if multiple users operate under a single customer profile. Thus, an appropriate party can select what features can be used with the customer profile.

### IV. Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for an automatic delivery schedule, the method comprising:
storing, via one or more processors, shipping data corresponding to an item to be delivered to a first delivery point by a carrier for a customer;
identifying, via the one or more processors, a customer-defined delivery schedule that identifies customer preferences for delivering items for the customer; and
after identifying the customer-defined delivery schedule, automatically updating, via the one or more processors, the shipping data corresponding to the item to reflect that the item should be re-routed for delivery to a second delivery point based on the customer-defined delivery schedule, wherein the item is subsequently delivered to the second delivery point.

2. The method of claim 1 further comprising:
storing a plurality of customer profiles corresponding respectively to a plurality of customers, wherein each customer profile comprises at least one address;
identifying an address of a first customer profile from the plurality of customer profiles that is substantially similar to the address for the item; and
after identifying the address of the first customer profile from the plurality of customer profiles that is substantially similar to the address for the item, associating the shipping data corresponding to the item with the first customer profile.

3. The method of claim 2, wherein the address is selected from the group consisting of a virtual address and a physical address.

4. The method of claim 1, wherein the shipping data is received from a scan of the item.

5. The method of claim 1 further comprising evaluating the item for delivery in accordance with the customer-defined delivery schedule.

6. The method of claim 1 further comprising determining whether the customer is associated with a customer-defined delivery schedule.

7. The method of claim 1 further comprising:
storing communication preferences for providing information regarding the item, wherein the communication preferences (1) identify at least one communication format and at least one corresponding electronic destination address to be used in providing the information to the customer, and (2) define a time period prior to a first delivery attempt of the item in which a message providing the information is to be transmitted to the at least one corresponding electronic destination address;
automatically generating a message providing the information regarding the item to be delivered to the customer; and
automatically transmitting the message to the at least one corresponding electronic destination address within the defined time period prior to the first delivery attempt of the item to the customer.

8. The method of claim 7, wherein the at least one communication format is selected from the group consisting of a text message, an email message, a voice message, a picture message, a video message, and a social media message.

9. An apparatus comprising at least one processor and at least one memory including computer program code, the at least one memory and the computer program code configured to, with the processor, cause the apparatus to at least:
store shipping data corresponding to an item to be delivered to a first delivery point by a carrier for a customer;
identify a customer-defined delivery schedule that identifies customer preferences for delivering items for the customer; and
after identifying the customer-defined delivery schedule, automatically update the shipping data corresponding to the item to reflect that the item should be re-routed for delivery to a second delivery point based on the customer-defined delivery schedule, wherein the item is subsequently delivered to the second delivery point.

10. The apparatus of claim 9, wherein the memory and computer program code are further configured to, with the processor, cause the apparatus to:
store a plurality of customer profiles corresponding respectively to a plurality of customers, wherein each customer profile comprises at least one address;
identify an address of a first customer profile from the plurality of customer profiles that is substantially similar to the address for the item; and
after identifying the address of the first customer profile from the plurality of customer profiles that is substantially similar to the address for the item, associate the shipping data corresponding to the item with the first customer profile.

11. The apparatus of claim 10, wherein the address is selected from the group consisting of a virtual address and a physical address.

12. The apparatus of claim 9, wherein the shipping data is received from a scan of the item.

13. The apparatus of claim 9, wherein the memory and computer program code are further configured to, with the processor, cause the apparatus to evaluate the item for delivery in accordance with the customer-defined delivery schedule.

14. The apparatus of claim 9, wherein the memory and computer program code are further configured to, with the processor, cause the apparatus to determine whether the customer is associated with a customer-defined delivery schedule.

15. The apparatus of claim 9, wherein the memory and computer program code are further configured to, with the processor, cause the apparatus to:
store communication preferences for providing information regarding the item, wherein the communication preferences (1) identify at least one communication format and at least one corresponding electronic destination address to be used in providing the information to the customer, and (2) define a time period prior to a first delivery attempt of the item in which a message providing the information is to be transmitted to the at least one corresponding electronic destination address;
automatically generate a message providing the information regarding the item to be delivered to the customer; and
automatically transmit the message to the at least one corresponding electronic destination address within the defined time period prior to the first delivery attempt of the item to the customer.

16. The apparatus of claim 15, wherein the at least one communication format is selected from the group consisting of a text message, an email message, a voice message, a picture message, a video message, and a social media message

17. A computer program product comprising at least one non-transitory computer-readable storage medium having computer-readable program code portions stored therein, the computer-readable program code portions comprising:
an executable portion configured to store shipping data corresponding to an item to be delivered to a first delivery point by a carrier for a customer;
an executable portion configured to identify a customer-defined delivery schedule that identifies customer preferences for delivering items for the customer; and
an executable portion configured to after identifying the customer-defined delivery schedule, automatically update the shipping data corresponding to the item to reflect that the item should be re-routed for delivery to a second delivery point based on the customer-defined delivery schedule, wherein the item is subsequently delivered to the second delivery point.

18. The computer program product of claim 17 further comprising:
an executable portion configured to store a plurality of customer profiles corresponding respectively to a plurality of customers, wherein each customer profile comprises at least one address;
an executable portion configured to identify an address of a first customer profile from the plurality of customer profiles that is substantially similar to the address for the item; and
an executable portion configured to, after identifying the address of the first customer profile from the plurality of customer profiles that is substantially similar to the address for the item, associate the shipping data corresponding to the item with the first customer profile.

19. The computer program product of claim 18, wherein the address is selected from the group consisting of a virtual address and a physical address.

20. The computer program product of claim 17, wherein the shipping data is received from a scan of the item.

21. The computer program product of claim 17 further comprising an executable portion configured to evaluate the item for delivery in accordance with the customer-defined delivery schedule.

22. The computer program product of claim 17 further comprising an executable portion configured to determine whether the customer is associated with a customer-defined delivery schedule.

23. The computer program product of claim 17 further comprising:
an executable portion configured to store communication preferences for providing information regarding the item, wherein the communication preferences (1) identify at least one communication format and at least one corresponding electronic destination address to be used in providing the information to the customer, and (2) define a time period prior to a first delivery attempt of the item in which a message providing the information is to be transmitted to the at least one corresponding electronic destination address;
an executable portion configured to automatically generate a message providing the information regarding the item to be delivered to the customer; and
an executable portion configured to automatically transmit the message to the at least one corresponding electronic destination address within the defined time period prior to the first delivery attempt of the item to the customer.

24. The computer program product of claim 23, wherein the at least one communication format is selected from the group consisting of a text message, an email message, a voice message, a picture message, a video message, and a social media message.
